(19) United States
(12) Patent Application Publication
(10) Pub. No.: US 2026/0249527 A1
(43) Pub. Date: Aug. 27, 2026

(54) MOLDING METHOD FOR A SOLE STRUCTURE

(71) Applicant: NIKE, Inc., Beaverton, OR (US)

(72) Inventors: Alison C. CHEW, Portland, OR (US); Sami M. FAKHOURI, Portland, OR (US); Timothy J. SLAMA, Beaverton, OR (US)

(73) Assignee: NIKE, Inc., Beaverton, OR (US)

(21) Appl. No.: 19/060,014

(22) Filed: Feb. 21, 2025

(51) Int. Cl. B29C 44/34; B29C 44/02; B29C 44/58; B29K 75/00; B29K 105/04; B29L 31/50

(52) U.S. Cl. CPC B29C 44/3403; B29C 44/02; B29C 44/583; B29K 2075/00; B29K 2105/04; B29L 2031/504

(57) ABSTRACT

A method of molding including mixing a molten polymeric material with a blowing agent, mixing a supercritical fluid with the molten polymeric material and the blowing agent, thereby forming a first mixture, injecting the first mixture into a mold cavity, wherein the mold cavity includes a lattice, solidifying the first mixture within the mold cavity, thereby forming a foamed article, and removing the foamed article from the mold cavity.

### FIELD

The present disclosure relates generally to molding foamed articles, particularly for footwear.

### BACKGROUND

This section provides background information related to the present disclosure which is not necessarily prior art.

Articles of footwear conventionally include an upper and a sole structure. The upper may be formed from any suitable materials to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

A sole structure generally includes a layered arrangement extending between a ground surface and the upper. One layer of the sole structure includes an outsole that provides abrasion-resistance and traction with the ground surface. The outsole may be formed from rubber or other materials that impart durability and wear-resistance, as well as enhance traction with the ground surface. The outsole may be a separate layer of the sole structure or may be a bottom surface of a sole when the sole structure is a unit sole with no additional layers. Another layer of the sole structure includes a midsole disposed between the outsole and the upper. The midsole provides cushioning for the foot and may be partially formed from a polymer foam material that compresses resiliently under an applied load to cushion the foot by attenuating ground-reaction forces. The midsole may additionally or alternatively incorporate a fluid-filled bladder to increase durability of the sole structure, as well as to provide cushioning to the foot by compressing resiliently under an applied load to attenuate ground-reaction forces. A sole structure may also include a comfort-enhancing insole or a sockliner located within a void proximate to the bottom portion of the upper, and a strobel attached to the upper and disposed between the midsole and the insole or sockliner.

Midsoles employing fluid-filled bladders typically include a bladder formed from two barrier layers of polymer material that are sealed or bonded together. The fluid-filled bladders are pressurized with a fluid such as air, and may incorporate tensile members within the bladder to retain the shape of the bladder when compressed resiliently under applied loads, such as during athletic movements. Generally, bladders are designed with an emphasis on balancing support for the foot and cushioning characteristics that relate to responsiveness as the bladder resiliently compresses under an applied load.

### BRIEF DESCRIPTION OF DRAWINGS

The drawings described herein are for illustrative purposes only of selected configurations and are not intended to limit the scope of the present disclosure.

FIG. 1 is a flowchart for a method for molding an article, such as a component for an article of footwear, in accordance with aspects hereof;

FIG. 2 is a top perspective view of a mold for manufacturing a sole structure of an article of footwear, in accordance with aspects hereof;

FIG. 3 depicts a schematic plan view of a footwear component manufacturing system, in accordance with aspects hereof;

FIG. 4 depicts a perspective view of a temperature conditioning temperature conditioning rack and a temperature control unit, in accordance with aspects hereof;

FIG. 5 depicts the temperature conditioning temperature conditioning rack and a temperature control unit of FIG. 4 having a quantity of molds, in accordance with aspects hereof;

FIG. 6 depicts the temperature conditioning temperature conditioning rack of FIG. 5 in a rear perspective view, in accordance with aspects hereof;

FIG. 7 depicts an end effector in a first configuration, in accordance with aspects hereof;

FIG. 8 depicts the end effector of FIG. 7 in a second configuration, in accordance with aspects hereof;

FIG. 9 depicts a perspective view of a mold, in accordance with aspects hereof;

FIG. 10 depicts a side view of the mold of FIG. 9, in accordance with aspects hereof;

FIG. 11 depicts a perspective view of a press, in accordance with aspects hereof;

FIG. 12 depicts a front view of the press from FIG. 11 in a first configuration, in accordance with aspects hereof;

FIG. 13 depicts a front view of the press from FIG. 11 in a second configuration with a mold, in accordance with aspects hereof;

FIG. 14A depicts a perspective view of a mold joined with a hot-runner plate forming a tooling assembly, in accordance with aspects hereof;

FIG. 14B depicts a partially exploded view of the tooling assembly of FIG. 14A showing a second mold plate separated from a mold ring plate, in accordance with aspects hereof;

FIG. 15A depicts a front view of the mold and hot-runner plate of FIG. 14A, in accordance with aspects hereof;

FIG. 15B depicts internal components of a the hot-runner plate of FIG. 15A, in accordance with an aspect hereof;

FIG. 15C depicts a cross-sectional view of the hot-runner plate of FIG. 15A, in accordance with aspects hereof ;

FIG. 16 depicts a side view of the mold and hot-runner plate of FIG. 14A, in accordance with aspects hereof;

FIG. 17 depicts a bottom plan view of the mold and hot-runner plate of FIG. 14A, in accordance with aspects hereof;

FIG. 18A depicts the press of FIG. 11 aligned with an injector, in accordance with aspects hereof;

FIG. 18B depicts the injection manifold, in accordance with aspects hereof;

FIG. 19 depicts the press and injector of FIG. 18 a paired, in accordance with aspects hereof;

FIG. 20 depicts a perspective view of the injector of FIG. 18, in accordance with aspects hereof;

FIG. 21 depicts a side view of the injector of FIG. 20, in accordance with aspects hereof;

FIG. 22 depicts a cross-sectional view of the injector of FIG. 20, in accordance with aspects hereof;

FIG. 23 depicts a perspective view of an unloader, in accordance with aspects hereof;

FIG. 24 depicts a side view of the unloader of FIG. 23, in accordance with aspects hereof;

FIG. 25 depicts a cross-section view of the unloader of FIG. 24 in a first configuration, in accordance with aspects hereof; and

FIG. 26 depicts a cross-section view of the unloader of FIG. 24 in a second configuration with a mold, in accordance with aspects hereof.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The method may be used to make a component for an article of footwear such as a midsole, a component of a midsole such as a cushioning pad, a part of footwear upper such as a foam element in a collar, a sockliner or a part of a sockliner, or an outsole or a part of an outsole; foam padding in protective equipment such as shinguards, shoulder pads, chest protectors, masks, helmets or other headgear, knee protectors, and other protective equipment; padding for a padded strap, for example for a golf bag or shoulder bag; an element placed in an article of clothing between textile layers; or may be used for other known padding applications for protection or comfort, especially those for which weight of the padding is a concern. The invention further provides padded articles including such foam, padding, or cushioning components.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first”, “second”, “third”, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In the discussion that follows, terms “about,” “approximately,” “substantially,” and the like, when used in describing a numerical value, denote a variation of +/−10% of that value, unless specified otherwise.

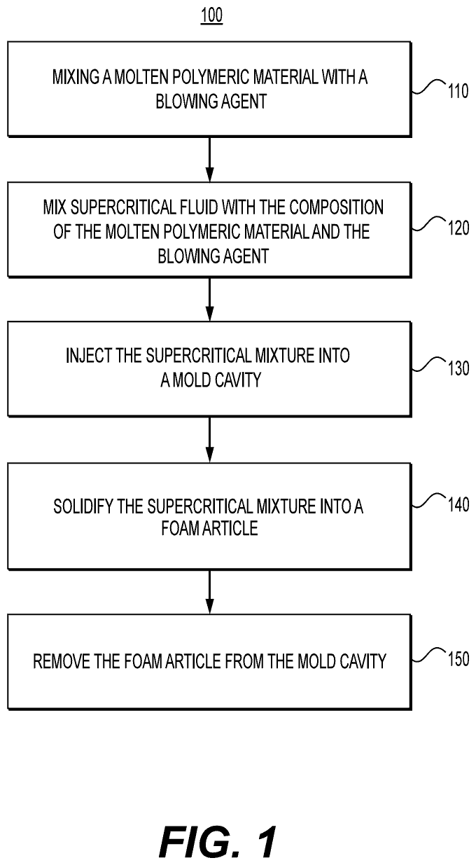

Articles or components of articles such as midsoles, midsole components, inserts, and insert components can be prepared by injection molding a melt composition described herein using a physical blowing agent. Referring to FIG. 1, a process 100 of preparing a molded article has a step 110 in which a molten polymeric material and a blowing agent are mixed together. In an example, the polymeric material comprises a thermoplastic copolyester elastomer. In step 120, a supercritical fluid is mixed with the composition of the molten polymeric material and the blowing agent.

In step 130, the mixture of the molten polymeric material, the supercritical fluid, and the blowing agent is injected into a mold cavity. In an example, the mold cavity includes a lattice. The lattice may be a foam lattice. For example, the lattice may be comprised of a second polymeric material. The mixture of the molten polymeric material, the supercritical fluid, and the blowing agent may be injected directly into portions of the lattice such that the mixture of the molten polymeric material, the supercritical fluid, and the blowing agent fills portions of the lattice. The injection molding can use a screw-type injector that allows for maintaining and controlling the pressure in the injector barrel. The injection molding machine can allow metering and delivering of the supercritical fluid, such as carbon dioxide or nitrogen, into the composition prior to injection. The supercritical fluid can be mixed into the composition within the injection barrel and then injected into the mold cavity. The supercritical fluid can then expand to create cell nuclei to form the physical foam within the mold cavity and the lattice. The injection molding can include physical foaming of the compositions using a microcellular foam injection molding process. The mixture of the molten polymeric material, the supercritical fluid, and the blowing agent and the lattice foamed together, thereby forming a foamed mixture. The foaming process includes the mixture of the molten polymeric material, the supercritical fluid, and the blowing agent and the lattice melting together to form the foamed mixture.

At step 140, the foamed mixture is solidified, thereby forming a foam article having a microcellular foam structure. In an example, the process for solidifying the foamed molten polymeric material includes cooling the mold to a temperature of from about 5° C. to about 80° C. over a period of from about 300 to about 1500 seconds. In an example, cooling may be carried out by moving the mold including the foamed molten polymeric material to a cold side of the compression chamber between two cold plates. In some examples, the cold side of the compression chamber may not include cold plates and may cool the foamed molten polymeric material by reducing the pressure on the cold side of the compression chamber. In general, a longer time may be used for cooling a thicker part. In some examples, the foamed molten polymeric material may be removed from the compression chamber after heating and allowed to passively cool via the ambient environment. A thicker part of the foamed molten polymeric material may be cooled over a longer period of time compared to the time in which a thinner part is cooled to the same temperature. In some examples, the part may be cooled over a period of from about 300 to about 1200 seconds or over a period of from about 300 to about 900 seconds. In some examples, the step 140 is begun as soon as a peak temperature is reached in step 130. The step 140 may be begun within 30 seconds, or within 10 seconds, or from about 0 to about 5 seconds, or immediately after the peak temperature is reached in step 130. The foamed molten polymeric material may be cooled at a rate of from about 0.09 to about 0.55° C./second.

In step 150 the foam article is removed from the mold cavity. The foam article has a 3D lattice shape. The foam article includes the foamed mixture interwoven with multiple polymeric materials. In an example, the foam article is compliant in every direction via the first polymeric material while providing stiffness and structure via the second polymeric material.

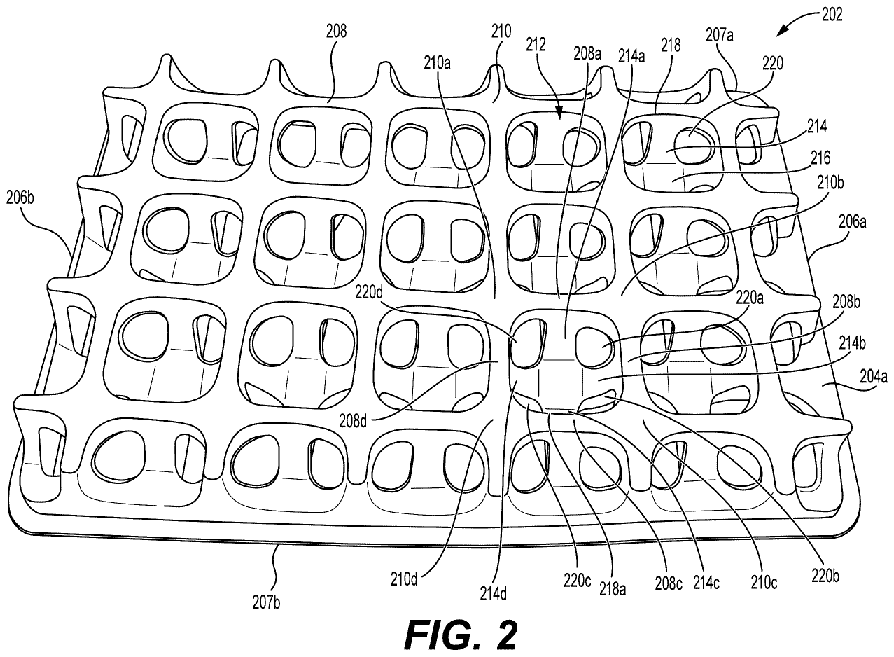

Referring to FIG. 2, the lattice 202 includes a first (bottom) surface 204a and a second (top) surface (not shown) opposite the first surface. The lattice 202 extends from a first end 206a to a second end 206b. In an example, the first end 206a is disposed in a plane that is offset from a plane of the second end 206b. In other words, the lattice 202 may taper from the first end 206a to the second end 206b. For example, if the mold were resting on a flat surface, the first end 206a would be disposed in a plane that is different from a plane of the second end 206b. The lattice 202 includes a first edge 207a and a second edge 207b. A portion of each of the first edge 207a and the second edge 207b disposed nearer the first end 206a is disposed in a plane that is offset from a plane of other portions of each of the first edge 207a and the second edge 207b disposed nearer the second end 206b. The lattice 202 includes one or more ribs 208 extending from the first end 206a to the second end 206, and extending from the first edge 207a to the second edge 207b. The one or more ribs 208 extend from the first surface 204a of the lattice 202 such that the one or more ribs 208 are disposed in a plane that is offset from a plane of the first surface 204a into the lattice 202. In some examples, the one or more ribs 208 continuously extend from the first end 206a to the second end 206, and from the first edge 207a to the second edge 207b. As will be described in greater detail below, the one or more ribs 208 provide structure for the lattice 202.

The one or more ribs 208 are interconnected between one or more bases 210. In an example, the one or more ribs 208 and the one or more bases 210 form a rectangular boundary surrounding one or more cavities 212. In some examples, the boundary of the one or more cavities 212 may be circular, ovular, rectangular, triangular, or any other desired shape. The lattice 202 includes one or more posts 214 extending from the one or more ribs 208 into the respective cavity of the one or more cavities 212. The one or more posts 214 extend and are connected to a footing 216. In an example, the one or more ribs 208, coupled with the one or more bases 210, the one or more posts 214, and the footing 216 forms a chamber 218 of a plurality of chambers 218. The chamber 218 surrounds a respective cavity of the one or more cavities 212. The chamber 218 includes one or more openings 220. The one or more openings 220 may be disposed between respective posts 214 of the one or more posts 214. In an example, chambers 218 disposed nearer the first end 206a are disposed in a plane that is offset from a plane of chambers 218 disposed nearer the second end 206b. The chambers 218 being disposed in such a manner allows for ease of coupling or mating with additional parts, as described later.

An exemplary chamber is described for ease of discussion, but it is contemplated that each of the chambers 218 may be substantially similar. In an example, a first chamber 218a is shown surrounding a first cavity 212a. The first chamber 218a includes a first rib 208a, a second rib 208b, a third rib 208c, and a fourth rib 208d. The first chamber 218a includes a first base 210a, a second base 210b, a third base 210c, and a fourth base 210d. The first rib 208a extends between the first base 210a and the second base 210b. The second rib 208b extends between the second base 210b and the third base 210c. The third rib 208c extends between the third base 210c and the fourth base 210d. The fourth rib 208d extends between the fourth base 210d and the first base 210a. The first chamber 218a includes a first post 214a, a second post 214b, a third post 214c, and a fourth post 214d. The first chamber 218a includes an inner rim 215. The first post 214a extends from the first rib 208a to the footing 216. The second post 214b extends from the second rib 208b to the footing 216. The third post 214c extends from the third rib 208c to the footing 216. The fourth post 214d extends from the fourth rib 208d to the footing 216. In an example, the first chamber 218a is square in shape as the ribs 208a, 208b, 208c, and 208d extending between the respective bases 210a, 210b, 210c, and 210d. In some examples, the first chamber 218a may be ovular, rectangular, triangular, or any shape desired

In an example, the first chamber 218a includes between about 1 and 12 posts 214. In some examples, the first chamber 218a includes between about 2 and 6 posts. In some examples, the first chamber 218a includes four posts 214. In other examples, the first chamber 218a includes any number of posts 214 as desired. In an example, the first chamber 218a includes a rounded surface such that the footing 116 is rounded and each of the posts 214a, 214b, 214c, and 214d are rounded. In the example, the first chamber 218a is rounded such that when the lattice 202 compresses other objects or molds, the second surface (not shown) of the first chamber 218a opposite the first surface 204a presses in a rounded manner to create a concave surface in the other object or mold.

A first opening 220a is disposed between the first post 214a and the second post 214b. A second opening 220b is disposed between the second post 214b and the third post 214c. A third opening 220c is disposed between the third post 214c and the fourth post 214d. A fourth opening 220d is disposed between the fourth post 214d and the first post 214a. In an example, each of the openings 220a, 220b, 220c, and 220d are circular in shape. In some examples, each of the openings 220a, 220b, 220c, and 220d may be ovular, rectangular, or square in shape. In some examples, some of the openings 220a, 220b, 220c, and 220d may have a first shape while other of the openings 220a, 220b, 220c, and 220d have a second shape. As will be described in greater detail below, respective portions of the chamber 218 are configured to engage with a block (i.e., a foam block).

As is shown in FIG. 2, one or more of the chambers 218 disposed along an outer periphery of the lattice 202 at the first end 206a, the second end 206b, the first edge 207a, and the second edge 207b are partial chambers 218. In other words, the chambers 218 disposed at the first end 206a, the second end 206b, the first edge 207a, and the second edge 207b may have less posts 214 and openings 220 than chambers 218 disposed at interior portions of the lattice 202. The partial chambers 218 disposed along the outer periphery of the lattice 202 may include an interior portion exposed to the external environment.

The lattice 202 may be mated or otherwise coupled with a mold block that may be compressed and extend through the openings of the lattice 202. In an example, the combination of the lattice 202 and the mold block may be heated and melted into a resultant sole structure. In some examples, the combination of the lattice 202 and the mold block are stamped or otherwise cut into the sole structure after the heating and melting occur. The sole structure forms a 3D lattice shape where a first material and a second material are integrally formed in the sole structure.

The articles molded by the disclosed process have lower densities and are lighter in weight while providing greater amounts of multi-zonal stiffness as compared to prior molded articles. Articles molded by the disclosed process do not require a separate heating step thus reducing manufacturing time and complexity. Additionally, removing the heating step allows for mixing of one or more foams that have different densities and/or expansion ratios as traditionally, foams mixed into a molded article have to have the same density and/or expansion ratio. For example, the articles molded by the disclosed process may include one or more zones of a desired level of cushioning. In some examples, the articles molded by the disclosed process may include three or more zones of a desired level of cushioning. In an example, the articles molded by the disclosed process includes five or more zones of a desired level of cushioning. This provides a more discrete desired form of cushioning and support when incorporated in articles of footwear. Prior articles of footwear could only incorporate at most four zones of a desired level of cushioning, and required that foams used in manufacturing of the articles of footwear had to have the same density and/or expansion ratio.

The molded article may be incorporated as cushioning into other articles. As non-limiting examples, the molded article may be a foam element in footwear, such as a part of a footwear upper, a foam element in a collar, a foam midsole or a part of a midsole, or an outsole or a part of an outsole; foam padding in shinguards, shoulder pads, chest protectors, masks, helmets or other headgear, knee protectors, and other protective equipment; padding in a padded strap, for example for a golf bag or shoulder bag; an element placed in an article of clothing between textile layers; or may be used for other known padding applications for protection or comfort, especially those for which weight of the padding is a concern.

In various examples, the molded article is a midsole for an article of footwear. A midsole provides cushioning in the footwear. A midsole should be durable but also preferably adds as little weight as possible to the footwear while still cushioning to the desired degree. A midsole also should be able to be bonded to an outsole, an upper, or any other components (e.g., a shank, an airbag, or decorative components) in making an article of footwear.

In other examples, the molded article is an outsole for an article of footwear. An outsole may be molded using a rigid thermoplastic polyurethane.

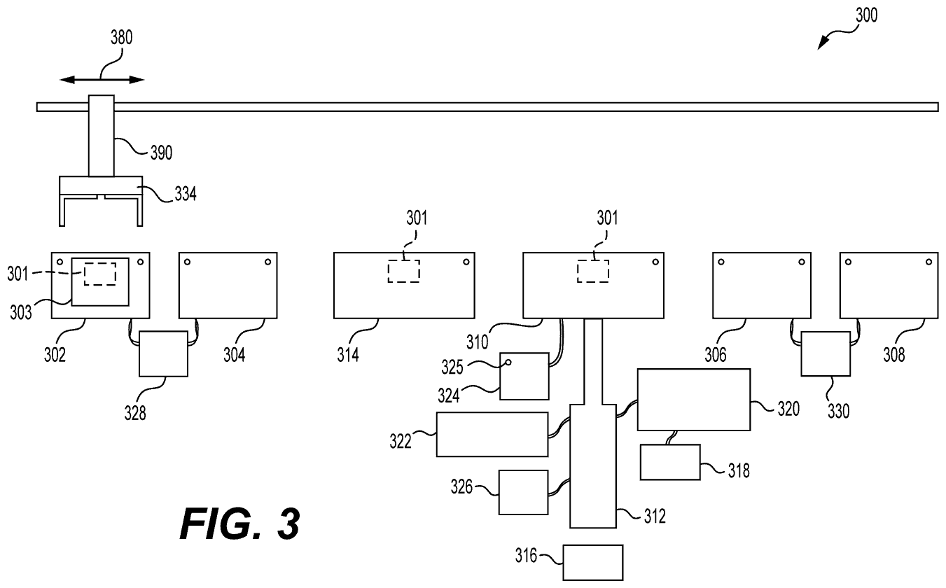

FIG. 3 depicts a schematic plan view of a footwear component manufacturing system 300, in accordance with aspects hereof. The arrangement of the components in the system 300 is provided to optimize throughput of the system 300, in an example. For example, temperature conditioning racks (e.g., temperature conditioning rack 302, 304, 306, 308) are positioned on both sides of an unloader 314 and a press 310. However, it is contemplated that depending on the configuration of the temperature conditioning racks, the process parameters, and the robot prioritization, that an alternative arrangement of components results in an optimized throughput of the system 300. For example, it is contemplated that at least one temperature conditioning rack (e.g., temperature conditioning rack 302, 304, 306, 308) may be positioned between the press 310 and the unloader 314 to provide optimized throughput on the system depending on the process parameters (e.g., injection time, resting time, robot velocity). Further, it is contemplated that the temperature conditioning racks 302, 304, 306, 308, the unloader 314, and the press 310 are all positioned within three meters of a common line that is parallel to the motion path 380. This relative positioning ensures an end effector 334 is effective to access each of the components without significantly sacrificing the throughput of the system 300 through excessive robot motion compensating for components of the system out of alignment relative to the motion path of the robot 390.

The system 300 is a non-limiting example of a system contemplated herein. It is understood that any number of individual components may be incorporated in the system. For example, four temperature conditioning racks are depicted, but it could be one temperature conditioning rack, two temperature conditioning racks, three temperature conditioning racks, five temperature conditioning rack, or any number of temperature conditioning racks. Similarly, an example of the positioning for the various components is provided for illustration purposes, but alternative positioning is contemplated. Further, the schematic illustration of FIG. 3 is merely for illustration purposes and is not limiting as to size, location, relative position, or scale. Further yet, it is contemplated that one or more components may be omitted from the system 300 and/or that one or more components may be introduced to the system 300.

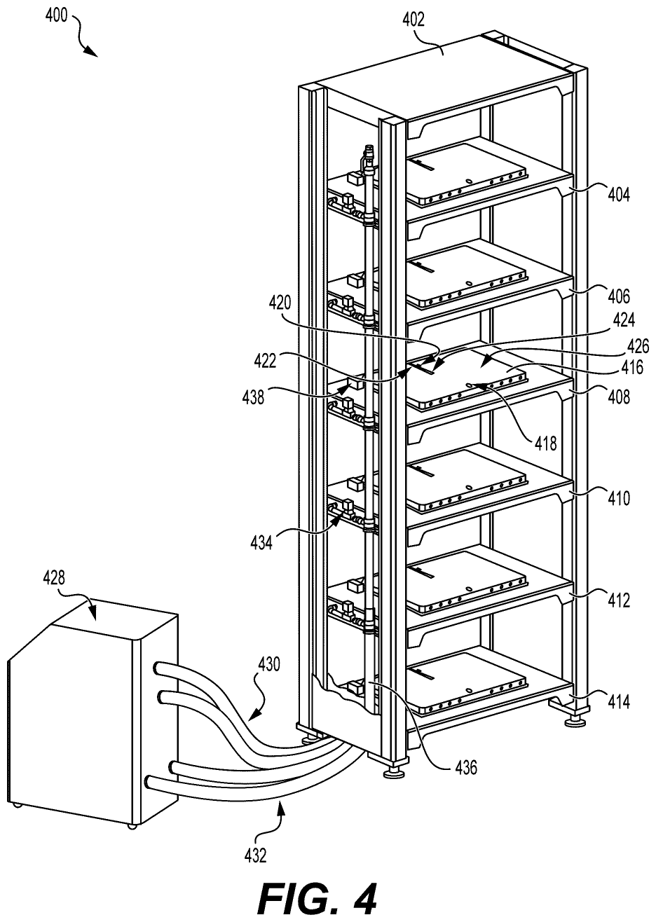

FIG. 4 depicts a perspective view 400 of a temperature conditioning rack 402 and a temperature control unit 428, in accordance with aspects hereof. The temperature conditioning rack 402 is comprised of a quantity of bays 404, 406, 408, 410, 412, and 414. The quantity of bays may be any number, such as one bay, two bays, three bays, four bays, six bays, seven bays, eight bays, nine bays, or ten bays. For example, the temperature conditioning rack 402 may include four to eight bays, in an example. The number of bays is selected as an optimization for system throughput. The number of bays are limited based on the minimum distance for the tooling to be maintained between the stacked bays and for the end effector of a robot to access, position, and remove the tooling from the bays. The height of the temperature conditioning rack is also limited, in some examples, to a height that is accessible by the robot, such as an arm-style robot having limited reach. Furthermore, the number of bays is limited, in part, by a capacity of the temperature control unit 428 to effectively condition a temperature for the number of bays. As such, aspects contemplated that the temperature conditioning rack 402 having four to eight bays satisfies the conditions identified and provides an effective throughput for the system. However, as process parameters, components, and/or conditions are adjusted, an alternative range of bays is contemplated and provided herein.

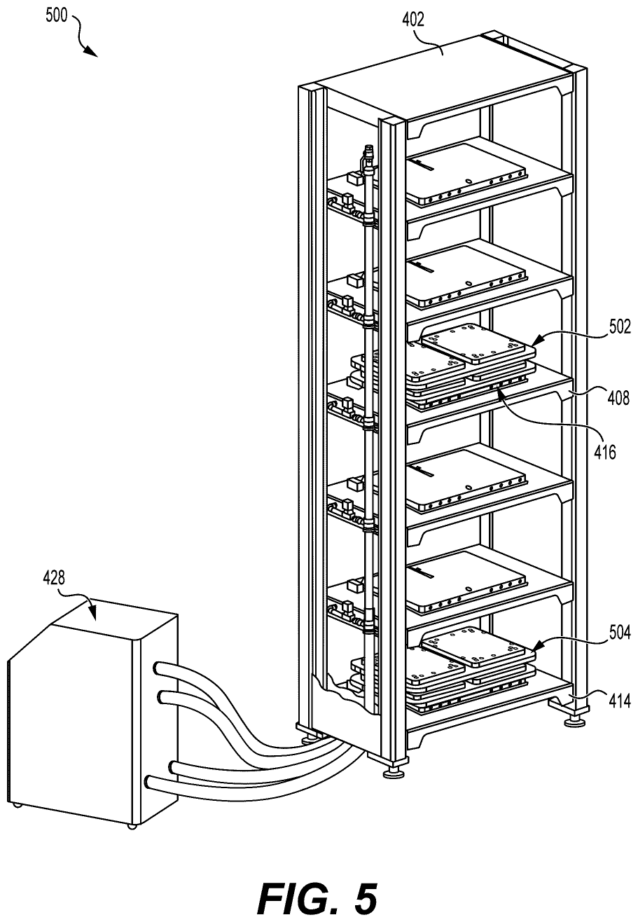

The six bays of the temperature conditioning rack 402 are each provided with a temperature conditioning plate, such as a temperature conditioning plate 416 in the bay 408. A temperature conditioning plate may be a separate component of the bay or it may be integrally formed in the bay. The temperature conditioning plate 416 is effective to condition a temperature of tooling placed thereon. For example, a mold 502 as shown in FIG. 5 is positioned on the temperature conditioning plate 416. The temperature conditioning plate 416, in an example, includes a top surface 426 that interfaces with the tooling (e.g., mold 502 of FIG. 5) when the tooling is positioned on the temperature conditioning plate 416 and the temperature conditioning plate 416 is comprised of a bottom surface that, in an example, is supported by the bay.

The temperature conditioning plate 416 includes a fluid channel (not shown) that extends between the top surface 426 and the bottom surface that begins at a fluid input port (not shown) and terminates at a fluid output port (not shown). The fluid input port is fluidly coupled with the temperature control unit 428 and the fluid output port is fluidly coupled with the temperature control unit 428 allowing for a circulation of temperature conditioning fluid between the temperature control unit 428 and the temperature conditioning plate 416. The temperature conditioning rack 402 also includes a temperature conditioning fluid manifold 436 that serves as a fluid coupling between the temperature control unit 428 and the temperature conditioning plate 416. The temperature conditioning fluid manifold 436 is effective to control the distribution of the temperature conditioning fluid from the temperature control unit 428 to the quantity of bays. This controlled distribution of the temperature conditioning fluid by the temperature conditioning fluid manifold 436 provides, in an example, a more equal temperature distribution of the temperature conditioning fluid among the quantity of bays.

The temperature conditioning fluid manifold 436 may have one or more valves that are dynamically or manually controlled to further control the distribution of the temperature conditioning fluid in an even (e.g., consistent flow rate, consistent temperature) manner. An example of a valve used by the temperature conditioning fluid manifold 436 is a valve 434. The valve 434 may be controlled by a controller to adjust a flow of the temperature conditioning fluid provided to the temperature conditioning plate 416. For example, if the temperature conditioning plate 416 is not being used, the valve 434 may restrict the flow of the temperature conditioning fluid in an effort to conserve energy used to temperature condition the temperature conditioning plate 416 when not conditioning the tooling. The temperature control unit 428 is fluidly coupled, at least in part, with the fluid input port via supply line 432 and the temperature control unit 428 is fluidly coupled, at least in part, with the fluid output port via return line 430. Each of the supply line 432 and the return line 430 may be fluidly coupled with a respective manifold (e.g., temperature conditioning fluid manifold 436).

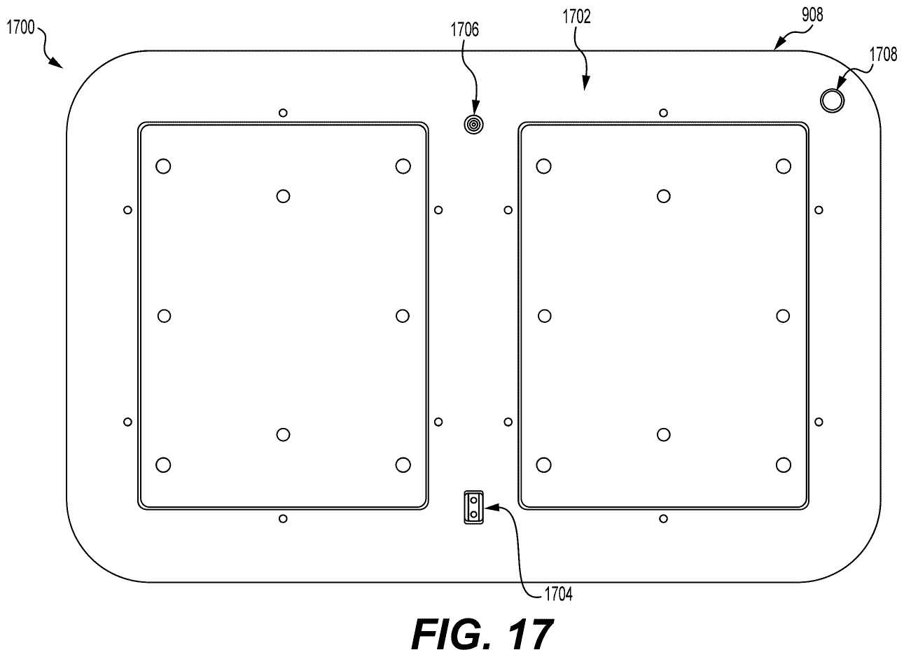

The temperature conditioning plate 416 also includes a first protrusion 418 extending outwardly from the top surface 426. The first protrusion 418 is sized, shaped, and positioned on the top surface 426 to be received by a first plate-alignment keyway 1704 of FIG. 17 in a bottom surface of the tooling, as will be discussed in greater detail in connection with FIG. 17 hereinafter. The top surface 426 is also comprised of a second protrusion 420 extending outwardly from the top surface 426. The second protrusion 420 is sized, shaped, and positioned on the top surface 426 to be received by a second plate-alignment keyway 1706 of FIG. 17 in a bottom surface of the tooling. The first protrusion 418 is asymmetrical with respect to the second protrusion 420 in one or more characteristics. Those characteristics include, but are not limited to, protrusion length extending from the top surface 426, the protrusion cross section as taken in a plane parallel to the top surface 426 are as taken in a plane perpendicular to the top surface 426, the position of the protrusion on the top surface 426, a size of the protrusion (e.g., width), or any combination.

The asymmetry between the first protrusion 418 and the second protrusion 420 is effective to ensure the tooling is positioned in a proper orientation and a proper location within a bay. This proper orientation and positioning ensure that the end effector (e.g., end effector 334 of FIG. 3), which operates with very tight tolerances (e.g., less than 2 millimeters) is capable of securing the tooling without intervention by a human operator. The proper orientation and positioning also ensures that the tooling having an RFID tag is positioned appropriately relative to an RFID reader 438 to be interrogated and confirmed in the specific bay. Further yet, the orientation and position confirmation provided by the asymmetry of the two protrusions also ensure that tooling is properly aligned with a thermocouple (e.g., thermocouple 424 of FIG. 4) of the temperature conditioning plate 416. In an example, the thermocouple 424 is placed in a recess 422 to prevent interference with the tooling as the tooling is positioned on and off of the temperature conditioning plate 416. In this example, the thermocouple 424 is recessed in the recess 422 such that the thermocouple is flush or slightly recessed from the top surface 426.

The temperature control unit 428 is effective to condition (e.g., heat or cool) a conditioning fluid to a temperature from 15 degrees Celsius to 90 degrees Celsius, from 50 degrees Celsius to 80 degrees Celsius, and/or from 55 degrees Celsius to 70 degrees Celsius. It is contemplated that the temperature control unit 428 services two or more temperature conditioning racks (e.g., temperature conditioning racks 302 and 304 of FIG. 3). For example, the temperature control unit 428 has a plurality of inlets and outlets to fluidly connect with a plurality of components, such as two temperature conditioning racks via the supply line 432 and the return line 430.

FIG. 5 depicts a configuration 500 having the temperature conditioning rack 402 and the temperature control unit 428 of FIG. 4 having a quantity of molds 502, 504, in accordance with aspects hereof. The first mold 502 is supported in bay 408 on the temperature conditioning plate 416. A second mold 504 of the quantity of molds is depicted in the bay 414.

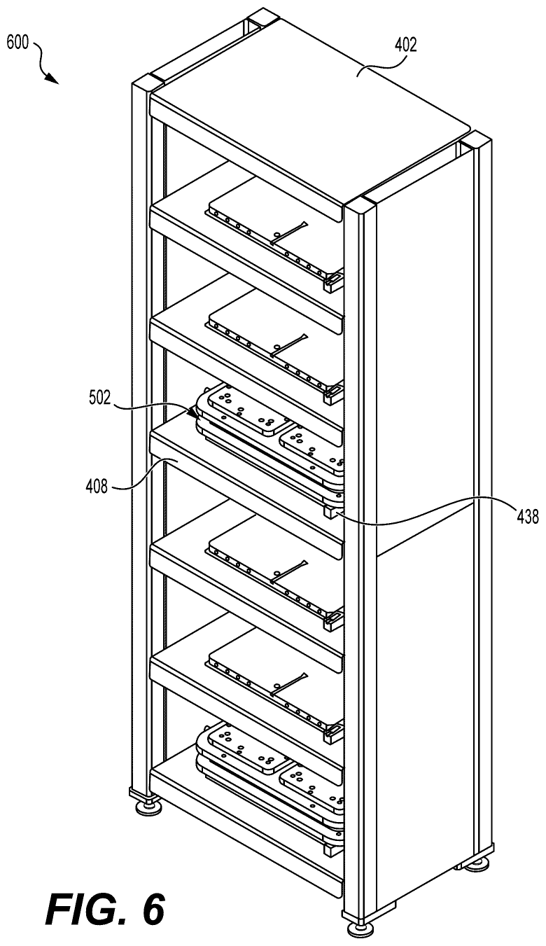

FIG. 6 depicts the temperature conditioning rack 402 of FIG. 5 in a rear perspective view 600, in accordance with aspects hereof. The back perspective view illustrates the second protrusion 420, the recess 422, and the RFID reader 438 with better clarity. FIGS. 4-6 provide an example temperature conditioning rack 402. It is understood that any size of temperature conditioning rack may be implemented having any number of bays, temperature conditioning plates, and configurations. Therefore, while FIGS. 4-6 provide and describe a specific temperature conditioning rack, it is not intended to be limiting to the system and methods provided herein.

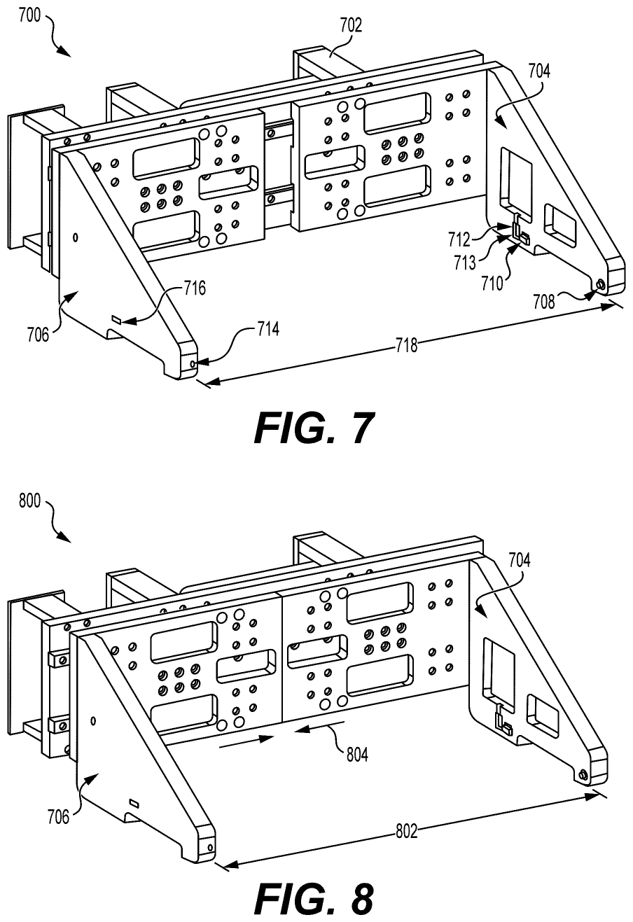

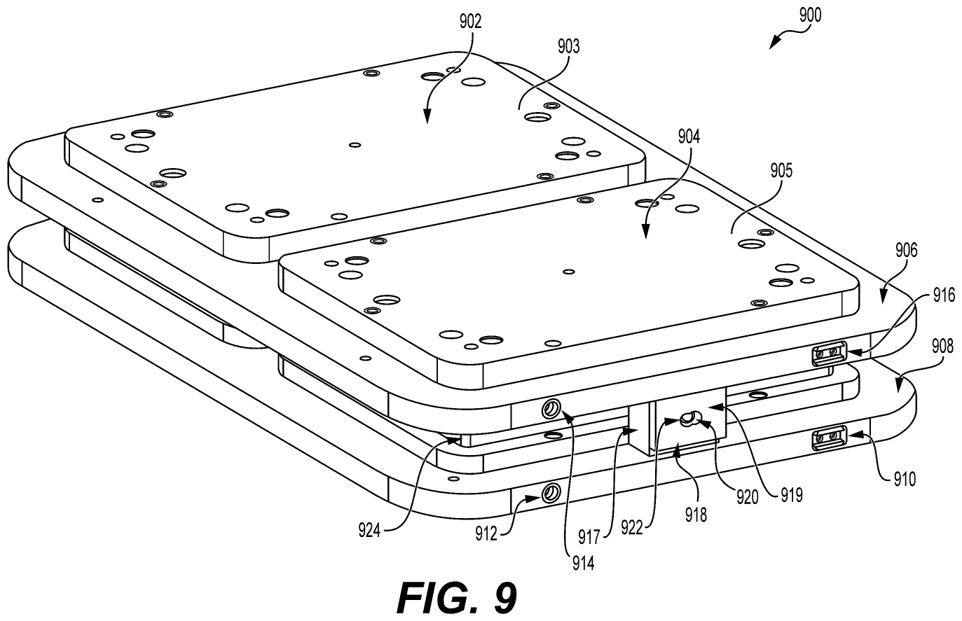

FIG. 7 depicts an end effector 702 in a first configuration 700, in accordance with aspects hereof. The end effector 702 is comprised of a first side 704 and a second side 706. The first side 704 and the second side 706 are slideably positioned on the end effector 702 to move between a first distance 718 and a second distance 802 depicted in FIG. 8. This slideable movement allows the first arm 704 and the second arm 706 to converge on a first side of tooling and a second side of the tooling (e.g., mold 900 of FIG. 9) respectively to engage the end effector 702 with the tooling. The tooling will be described relative to FIG. 9 hereinafter.

The first arm 704 and the second arm 706 are in a parallel configuration such that as the first arm 704 and the second arm 706 position between the first distance and the second distance, they converge on the tooling and align with the tooling to work within the tight tolerances of the robot controlling the end effector 702. Stated differently, the first arm 704 and the second arm 706 remain parallel to sides of the tooling to which they will engage as the first arm 704 and the second arm 706 move into an engagement configuration. The parallel arrangement allows for secured engagement and operation within tight tolerances.

The first arm 704 is comprised of a first protrusion 708 and a second protrusion 710. Each of the first protrusion 708 and the second protrusion 710 extend outwardly from the first arm 704 toward the second arm 706. Similarly, the second arm 706 is comprised of a third protrusion 714 and a fourth protrusion 716 that extend outwardly from the second arm 706 toward the first arm 704. The first protrusion 708 is asymmetrical with respect to the second protrusion 710 in one or more characteristics. The characteristics include, but are not limited to, the protrusion length, protrusion cross section shape, protrusion position, protrusion size, and any combination thereof. Similarly, the third protrusion 714 is asymmetrical with respect to the fourth protrusion 716 in one or more characteristics. The characteristics include, but are not limited to the protrusion length, protrusion cross section shape, protrusion position, protrusion size, and any combination thereof. It is contemplated that the first protrusion 708 and the third protrusion 714 are symmetrical in one or more characteristics and the second protrusion 710 and the fourth protrusion 716 are symmetrical in one or more characteristics. For example, the first protrusion 708 may have a cylindrical volume while the second protrusion 710 may be a rectilinear volume. In this example, the second protrusion 710 having the rectilinear volume would not engage with a keyway configured to receive a cylindrical volume of the first protrusion 708.

The characteristics of each protrusion are adapted to be received in and therefore engage with a respective keyway in a tool, such as a mold. This coordination between protrusion characteristics and an associated keyway allows for the end effector 702 to securely engage the tool in a known location and orientation to similarly position the tool at a known location and orientation.

The end effector 702 is comprised of an RFID reader 713 that is received in a recess 712 of the first arm 704. The position of the recess 712 is selected such that the RFID reader 713 is capable of interrogating an RFID tag (e.g., RFID tag 1708 of FIG. 17) on a specific location of an engaged mold (e.g., mold 900 of FIG. 9). The close proximity between the RFID reader 913 and the RFID tag limits identification errors or failures to interrogate the RFID tag. As previously provided, the RFID reader 913 of the end effector 702 is effective to report the RFID tag identification to a controller for process management and system coordination. The end effector 702 is also comprised of a movement mechanism, such as an electric linear actuator, a pneumatic actuator, a hydraulic actuator, or other drive system (not shown). The movement mechanism responds to a command to adjust the distance between the first arm 704 and the second arm 706. Stated differently, the movement mechanism is mechanically joined with the first arm 704 and/or the second arm 706 to adjust a relative position of the first arm 704 and/or the second arm 706 to engage and disengage with a mold (e.g., mold 900 of FIG. 9) between the first arm 704 and the second arm 706.

FIG. 8 depicts the end effector 702 of FIG. 7 in a second configuration 800, in accordance with aspects hereof. As depicted in FIG. 8, the first arm 704 and the second arm 706 converge in a sliding motion depicted by directional indicators 804. This convergence results in a distance 802 extending between the first arm 704 and the second arm 706. This second configuration 800 is appropriate to engage with and secure a mold (e.g., mold 900 of FIG. 9), in an example.

The end effector 702 of FIGS. 7 and 8 is a non-limiting example of an end effector contemplated herein. While specific structures, configurations, and elements are depicted and described, it is contemplated that additional or alternative structures, configurations, and/or elements may form an end effector effective in the system and methods contemplated herein.

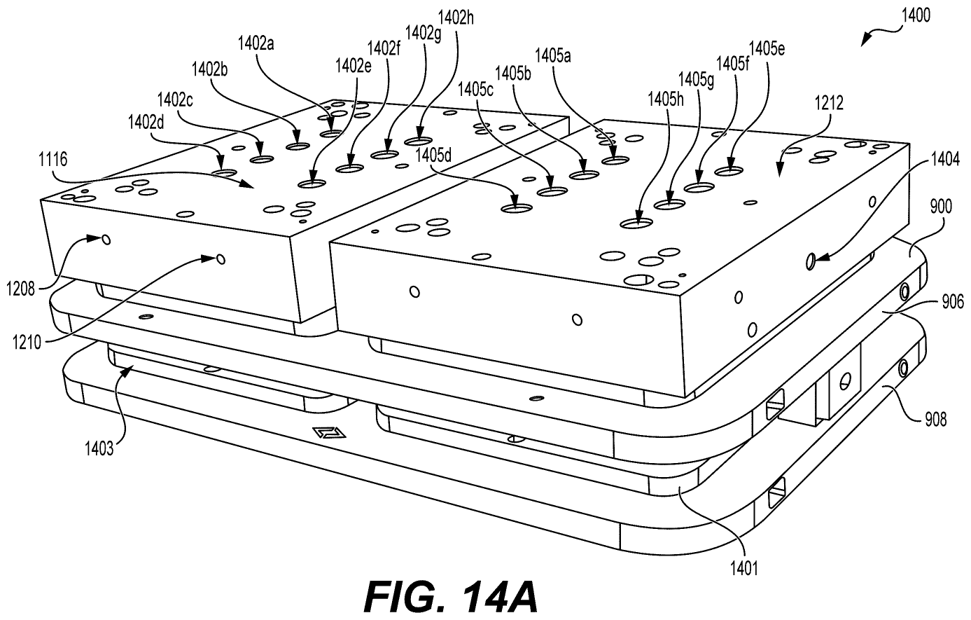

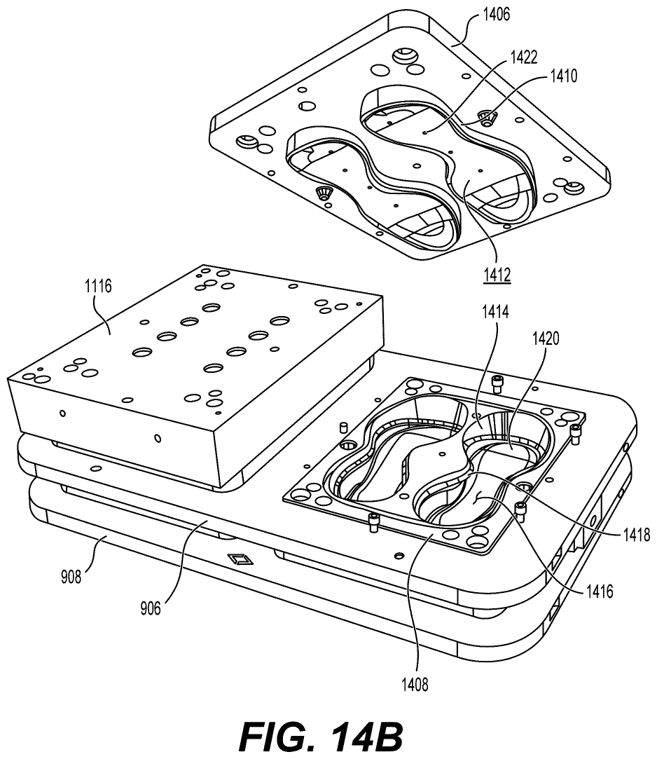

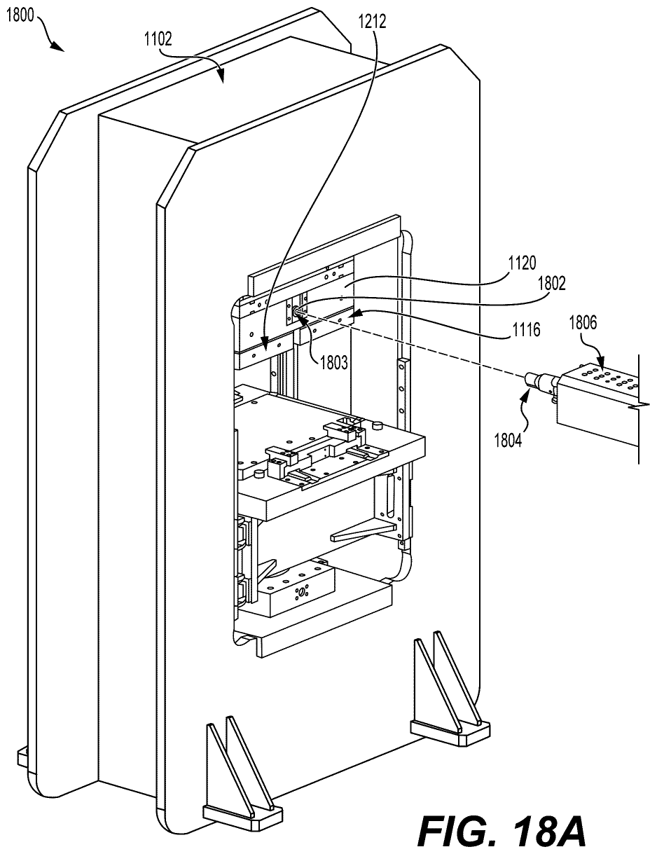

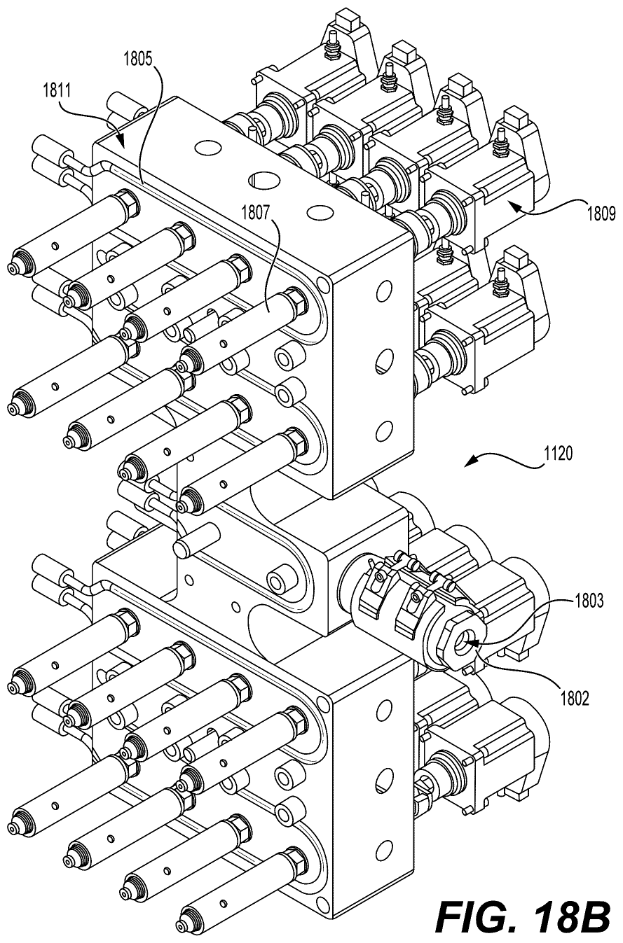

FIG. 9 depicts a perspective view of a mold 900, in accordance with aspects hereof. The mold 900 is a specific form of a tool or tooling as commonly referenced herein. Alternative tooling, such as alternative molds, are contemplated as being utilized and effective in the system and methods provided herein. The mold 900 is comprised of a first mold portion 903 and a second mold portion 905. It is contemplated that each of the mold portions 903, 905 includes a mold cavity (e.g., mold cavity 1420 of FIG. 14A) effective to form a component (e.g., footwear sole component) using the system and methods provided herein. For example, the first mold portion 903 is effective to form a right sole portion and a left sole portion for a pair of footwear. Similarly, the second mold portion 905 is effective to form a right sole portion and a left sole portion to form a second pair of footwear. In this example, the first mold portion 903 is comprised of a first mold cavity for the right sole and a second mold cavity for the left sole. The second mold portion 905 is comprised of a third mold cavity for the right sole of the second pair and a fourth cavity for the left sole of the second pair. It is contemplated that the mold cavity volumes of the first mold portion 903 is similar to or equal to the mold cavity volumes of the second mold portion 905. This commonality in mold volumes allows for consistent injection volumes as distributed by a manifold (e.g., injection manifold 1811 of FIG. 18B) serving as a conduit between an injector and the mold cavities. Maintaining consistency between mold volumes that are injected with a common injection shot from an injector provides greater control on the resulting product, in an example.

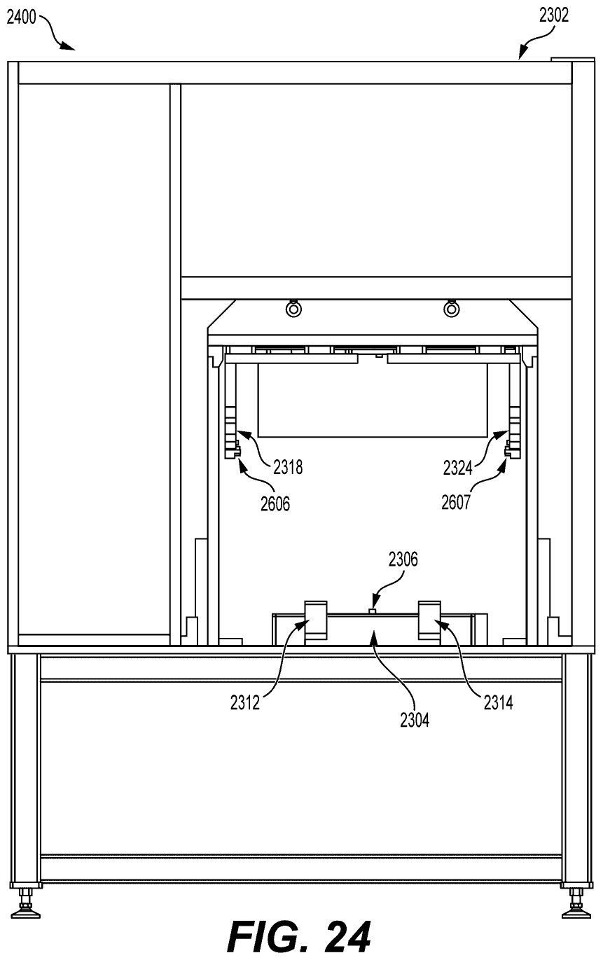

The mold 900 is comprised of a first top mold plate 902 and a second top mold plate 904. The mold 900 is comprised of a first carrier plate 908 and a second carrier plate 906. The mold 900 is comprised of a ring mold plate 924 and a tooling latch assembly 918. The tooling latch assembly 918 is comprised of a first portion 917 extending from the first carrier plate 908 towards the second carrier plate 906 and a second portion 919 extending from the second carrier plate 906 towards the first carrier plate 908. The first portion 917 and the second portion 919 of the tooling latch assembly 918 are offset and parallel positioned to interface and join when a biased pin 922 extending out from the first portion 917 towards the second portion 919 and extends, when in the biased position, into an aperture 920 of the second portion 919. The biased pin 922 may be manipulated by a key (e.g., key 2606 of FIG. 24) from an unloader (e.g., unloader 2300 of FIG. 24) to recess the biased pin 922 from the aperture 920 allowing the first portion 917 and the second portion 919 to slideably disengage and the first carrier plate 908 to distance itself from the second carrier plate 906, which allows the mold 900 to open. Having the biased pin 922 engaged in the aperture 920, the mold 900 is latched in a closed position.

Each of the carrier plates 906, 908 include keyways intended to engage with protrusion from different components of the system, as will discussed in more detail hereinafter. The first carrier plate 908 is comprised of a first plate-manipulator keyway 912 and a second plate-manipulator keyway 910. The second carrier plate 906 is comprised of a first plate-opening keyway 914 and a second plate-opening keyway 916. The first plate-manipulator keyway 912 and the second plate-manipulator keyway 910 are asymmetrical in at least one characteristic. The one or more characteristics include a keyway depth, cross section shape, position, size, or any combination. For example, the first plate-manipulator keyway 912 has a cylindrical volume and the second plate-manipulator keyway 910 has a rectilinear volume.

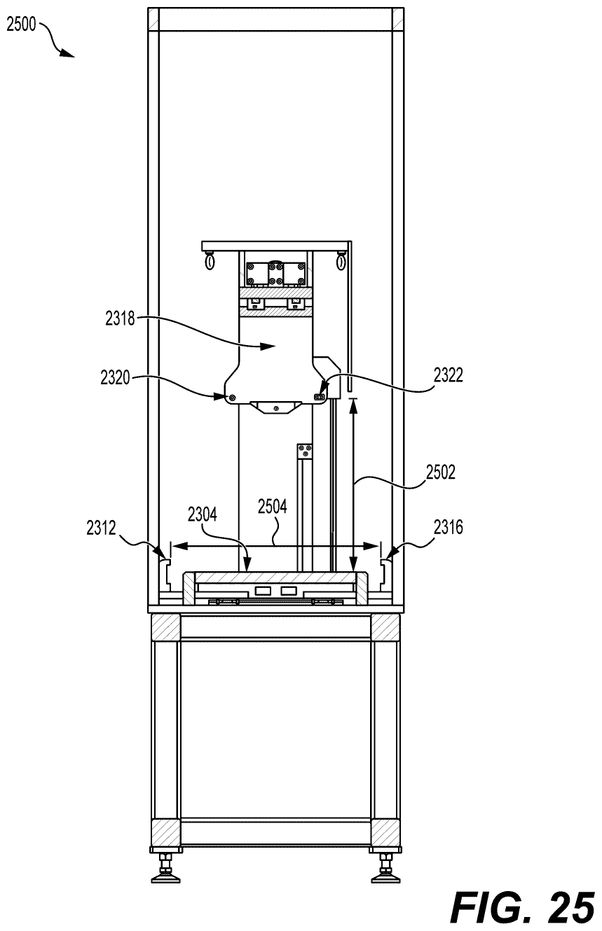

In practice, the first plate-manipulator keyway 912 is adapted to receive the third protrusion 714 of the end effector 702 from FIG. 7 and the second plate-manipulator keyway 910 is adapted to receive the fourth protrusion 716 of the end effector 702 from FIG. 7. Similarly, the first plate-opening keyway 914 is adapted to receive a first protrusion 2320 from an unloader 2300 that will be discussed in connection with FIG. 25 and the second plate-opening keyway 916 is adapted to receive a second protrusion 2322 from the unloader 2300 of FIG. 25. The opposite side of the tooling from the location of the first plate-manipulator keyway 912, the second plate-manipulator keyway 910, the first plate-opening keyway 914, and the second plate-opening keyway 916 is contemplated to have similar keyways. The similar keyways may be symmetrical to the respective keyway on the depicted side of FIG. 9. Alternatively, it is contemplated that the keyways on the opposite side of the mold 900 from the side depicted in FIG. 9 are asymmetrical in one or more characteristics to their respective keyways on the depicted side of the mold 900 in FIG. 9.

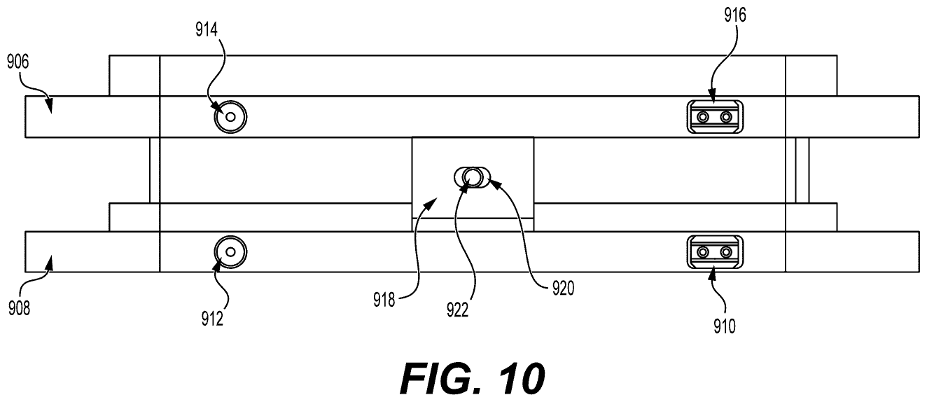

FIG. 10 depicts a side view of the mold 900 discussed in connection with FIG. 9, in accordance with aspects hereof. The mold 900 is provided as a non-limiting example for tooling that may be implemented in the system and method contemplated herein. The tooling may produce alternative foamed components; have alternative elements, alternative configurations, alternative sizing, and alternative configurations. As such, the system and methods contemplated herein may implement alternative tooling within the cope contemplated.

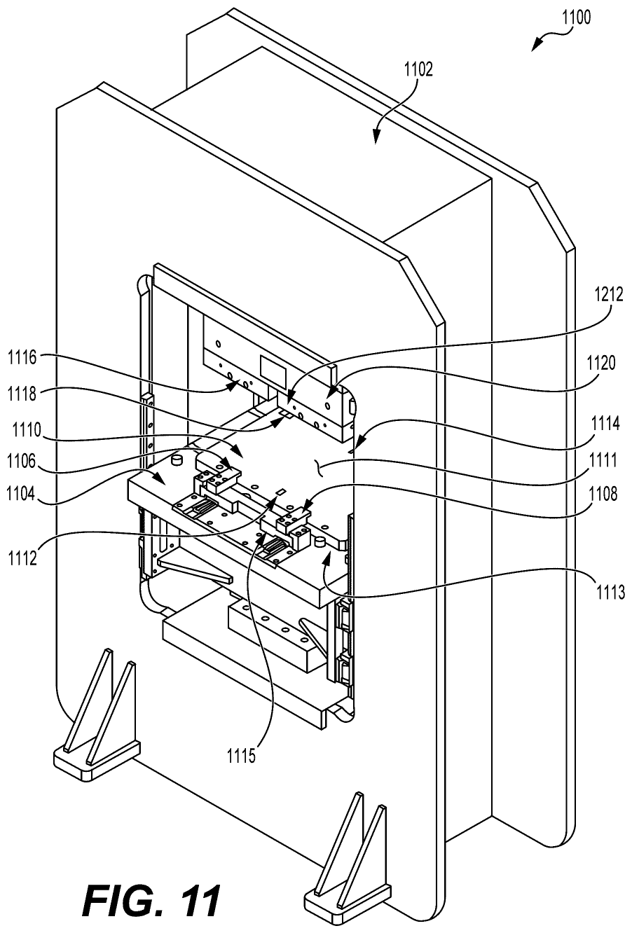

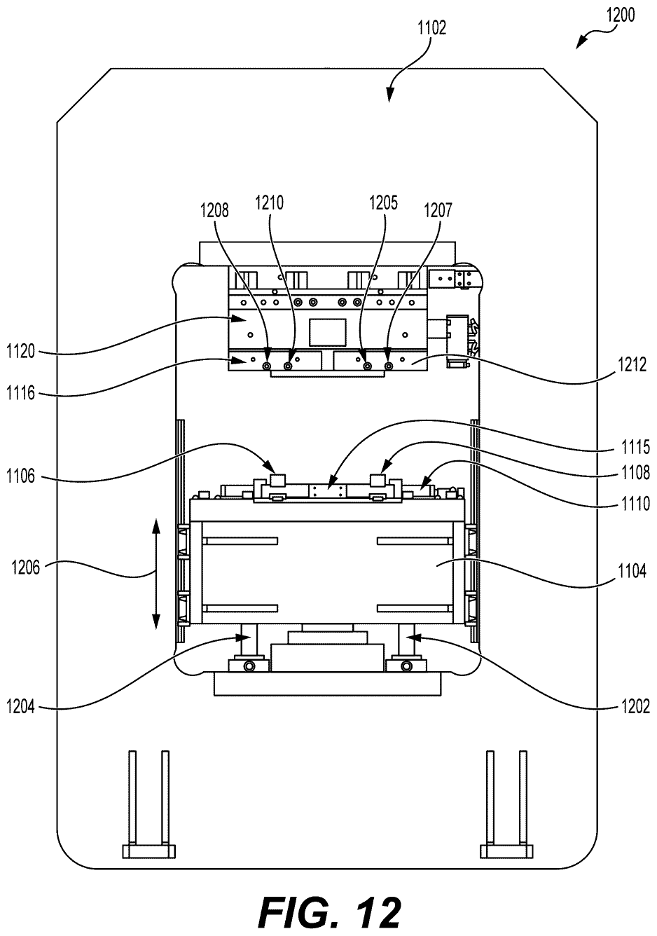

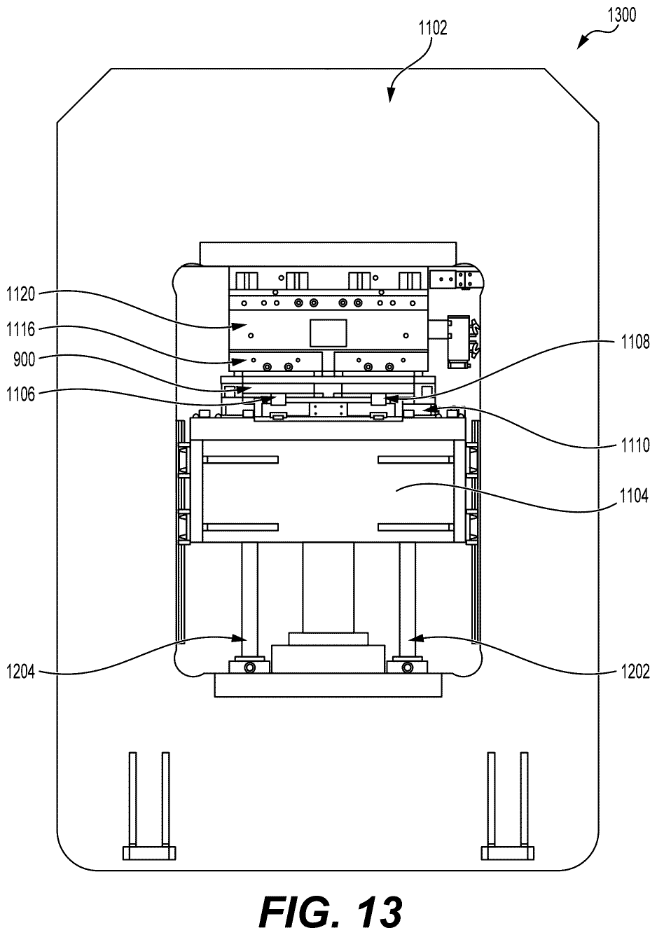

FIG. 11 depicts a perspective view of a press 1100, in accordance with aspects hereof. The press 1100 has a frame 1102 with a moveable support platform 1104. The moveable support platform 1104 is moveable by one or more actuators, such as a first actuator 1202 of FIG. 12 and a second actuator 1204 also of FIG. 12. The press 1100 also includes a press plate 1110 that has a top surface 1111 and an opposite bottom surface 1113. The press plate bottom surface 1113 is positioned on the moveable support platform 1104 and the press plate top surface 1111 is positioned to receive and support a tooling, such as the mold 900 form FIG. 9. The press 1100 also includes a press lock 1115 that is moveable between a locked configuration and an unlocked configuration. In the locked configuration, the press lock 1115 secures a tooling (e.g., mold 900 as depicted in FIG. 13), such as through engagement with a first carrier plate 908 of the mold 900 from FIG. 9. The press lock 1115 includes a pair of sliding fingers 1106, 1108 that move in a direction transverse to a direction that the moveable support platform 1104 moves. The pair of sliding fingers include a first finger 1106 and a second finger 1108. The first finger 1106 and the second finger 1108 are able to move in unison to engage a common surface of the tooling to secure the tooling to the press plate 1110. A second pair of fingers (not shown) also move in a direction transverse to a direction that the moveable support platform 1104 moves and in a direction of disagreement with the pair of sliding fingers 1106, 1108. The pair of fingers 1106, 1108 and the second pair of fingers work in cooperation to secure the tooling (e.g., mold 900 as depicted in FIG. 13) to the press plate 1110. The press plate 1110 also includes a first protrusion 1112 extending from the top surface 1111 toward a hot-runner plate 1116 and a second hot-runner plate 1212. The press plate 1110 also includes a second protrusion 1114 extending from the top surface 1111 toward the hot-runner plate 1116 and the second hot-runner plate 1212.

The first protrusion 1112 is asymmetrical with respect to the second protrusion 1114 in one or more characteristics. Those characteristics include, but are not limited to, protrusion length extending from the top surface of the press plate 1110, the protrusion cross section as taken in a plane parallel to the top surface of the press plate 1110, the position of the protrusion on the top surface of the press plate 1110, a size of the protrusion (e.g., width), or any combination.

The asymmetry between the first protrusion 1112 and the second protrusion 1114 is effective to ensure the tooling (e.g., mold 900 as depicted in FIG. 13) is positioning in a proper orientation and a proper location within the press 1100. This proper orientation and positioning ensure that the tooling aligns with the hot-runner plate 1116 and, by extension, and injection manifold 1120 that serves as a conduit for injected polymeric composition to the tooling. The proper orientation and positioning also ensures that the tooling having an RFID tag is positioned appropriately relative to an RFID reader 1118 to be interrogated and confirmed in the press 1100. Further yet, the orientation and position confirmation provided by the asymmetry of the two protrusions 1112, 1114 also ensure that tooling is properly aligned with a thermocouple of the press plate 1110, if present.

The first protrusion 1112 and the second protrusion 1114 operate in a manner similar to the first protrusion 418 and the second protrusion 420 of the temperature conditioning rack 402 discussed in connection with FIG. 4. Stated differently, common alignment keyways in the tooling are effective for aligning the tooling in at least two components of the system, such as the temperature conditioning rack 402 and the press 1100.

The press plate 1110, in an example, includes a conditioning fluid channel (not shown) extending between the top surface 1111 and the bottom surface 1113. The conditioning fluid channel has an inlet (not shown) and an outlet (not shown) allowing the press plate 1110 to be fluidly coupled with a temperature control unit. In this way, the press plate 1110 may function to condition tooling during and/or after an injection, in part, in a manner similarly described with the temperature conditioning plate 416 of the temperature conditioning rack 402 of FIG. 4.

FIG. 12 depicts a front view of the press 1100 from FIG. 11 in a first configuration 1200, in accordance with aspects hereof. The first configuration 1200 has the moveable support platform 1104 in a retracted platform position. The first actuator 1202 and the second actuator 1204 may be any type of actuator, such as a pneumatic actuator, hydraulic actuator, electric linear actuator, or the like. The positioning of the moveable support platform 1104 allows the press 1100 to secure the tooling (e.g., mold 900 as depicted in FIG. 13) against the hot-runner plates 1116, 1212 to form an effective seal allowing the single-phase solution to fluidly pass from the press 1100 to the tooling and for gas counter pressure to be maintained in the cavity of the tooling as passed from the press 1100. The first configuration 1200 having the moveable support platform 1104 in a retracted platform position allows for tooling, such as the mold 900 of FIG. 9 to be positioned on the press plate 1110 and may be secured by the press lock 1115.

The hot-runner plate 1116, 1212 is statically positioned, such as through bolts, latches or other securements, to the press. In this manner, as the moveable support platform 1104 moves from the first configuration 1200 to a second configuration 1300 depicted in FIG. 13, a distance between the moveable support platform 1104 and the hot-runner plate 1116, 1212 reduces such that the distance in the first configuration 1200 is greater than the distance in the second configuration 1300.

The hot-runner plate, such as the hot-runner plate 1116, provides a mechanism for keeping the molten polymeric composition within the injection manifold 1120 in a molten state. To accomplish this, the hot-runner plate 1116 is comprised of a channel (not shown) within the hot-runner plate 1116 that is effective to circulate conditioning fluid that is at a temperature to heat the hot-runner plate 1116 and associated injection manifold 1120 to a temperature sufficient for maintaining the molten polymer in a molten state between injections. The hot-runner plate 1116 is comprised of an inlet 1208 and an outlet 1210 that are fluidly coupled by the channel extending through the hot-runner plate 1116 for circulating the conditioning fluid.

A second hot-runner plate 1212 provides a mechanism for keeping the molten polymeric composition within the injection manifold 1120 in a molten state. To accomplish this, the hot-runner plate 1212 is comprised of a channel (not shown) within the hot-runner plate 1212 that is effective to circulate conditioning fluid that is at a temperature to heat the hot-runner plate 1212 and associated injection manifold 1120 to a temperature sufficient for maintaining the molten polymer in a molten state between injections. The hot-runner plate 1212 is comprised of an inlet 1205 and an outlet 1207 that are fluidly coupled by the channel extending through the hot-runner plate 1212 for circulating the conditioning fluid.

The use of a hot-runner plate (e.g., the hot-runner plate 1116, second hot-runner plate 1212) in this physical foaming operation reduces waste created from extended cold runners extending between an injector 312 of FIG. 3 and the tooling. By keeping a portion of the conduit between the injector and the tooling as a hot runner, the polymeric composition does not solidify between injections in those portions heated by the hot-runner plate 1116, 1212. Additionally, as previously discussed, the timing between injecting the polymeric composition into the tooling and reducing the gas counter pressure is responsible for the acceptability of the foamed part, in an example. This timing, which could be 1 second, 2 seconds, 3 second, 4 seconds, 5 seconds, or 6 seconds depending on injection volume, mold cavity characteristics, runner characteristics, and other variables, can be influenced by the temperature of the molten polymeric composition being injected. Therefore, as the injector 312 is dosing for a subsequent injection, different times may elapse between shots and therefore the molten polymeric composition in the manifold (e.g., manifold 1811 of FIG. 18B) or other locations of the runner system or injector 312 may drop in temperature at different levels without the hot-runner plate (e.g., the hot-runner plate 1116, second hot-runner plate 1212). Therefore, in an example, the hot-runner plate (e.g., the hot-runner plate 1116, second hot-runner plate 1212) is applied to the system in order to achieve consistent foamed components regardless of timing between injections or other variables during successive injections.

FIG. 13 depicts a front view of the press 1100 from FIG. 11 in the second configuration 1300 with the mold 900, in accordance with aspects hereof. As depicted, the moveable support platform 1104 is elevated bringing the mold 900 into fluid communication with the hot-runner plate 1116, 1212. As previously discussed, this fluid communication allows for a transfer of single-phase solution from the injector 312 by way of the injection manifold 1120 through the hot-runner plate 1116, 2121 to the cavities of the mold 900 while remaining in a single-phase solution. Similarly, the fluid communication between the hot-runner plate 1116, 1212 and the mold 900 allows for counter pressure to supplied to the mold 900 from a gas counter pressure supply, such as the gas counter pressure source 226 of FIG. 2.

The injection manifold 1120 distributes the single-phase solution from the injector 312 to the mold 900 through the hot-runner plate(s) 1116, 1212. The injection manifold 1120 also maintains the single-phase solution as a single-phase solution between successive shots or injections into tooling. The manifold accomplishes this, in part, through valves that are opened when the fluid communication is created by the press 1100 between the mold 900 and the hot-runner plate 1116. 1212 as the injection manifold 1120 contacts the mold 900 though the hot-runner plate (e.g., the hot-runner plate 1116, second hot-runner plate 1212), in an example.

The press 1100 is depicted having a specific configuration, structure, and arrangement; however, the press 1100 is a non-limiting example of a press contemplated herein. Alternative arrangements, such as omission of a hot-runner plate, a press plate, alternative actuators, alternative press locking mechanisms, and the like are all contemplated with the scope of the system and methods provided herein.

FIG. 14A depicts a perspective view of the mold 900 having a first mold portion 1401 and a second mold portion 1403 in fluid communication with the hot-runner plates 1116 and 1212 forming a tooling assembly 1400, in accordance with aspects hereof. A gas counter pressure port 1404 is depicted as extending from a side of the hot-runner plate 1212. The gas counter pressure port 1404 provides a conduit through the hot-runner plate 1212 for fluidly coupling the gas counter pressure supply with the cavity (e.g., mold cavity 1420 of FIG. 14B) of the mold 900 in the second portion associated with the hot-runner plate 1212. A similar gas counter pressure port extends through the hot-runner plate 1116 on an opposite that is out of view in FIG. 14A. The gas counter pressure port (not shown) of the hot-runner plate 1116 also provides a conduit through the hot-runner plate 1116 for fluidly coupling the gas counter pressure supply with the cavity of the mold 900 in a portion of the mold 900 associated with the hot-runner plate 1116.

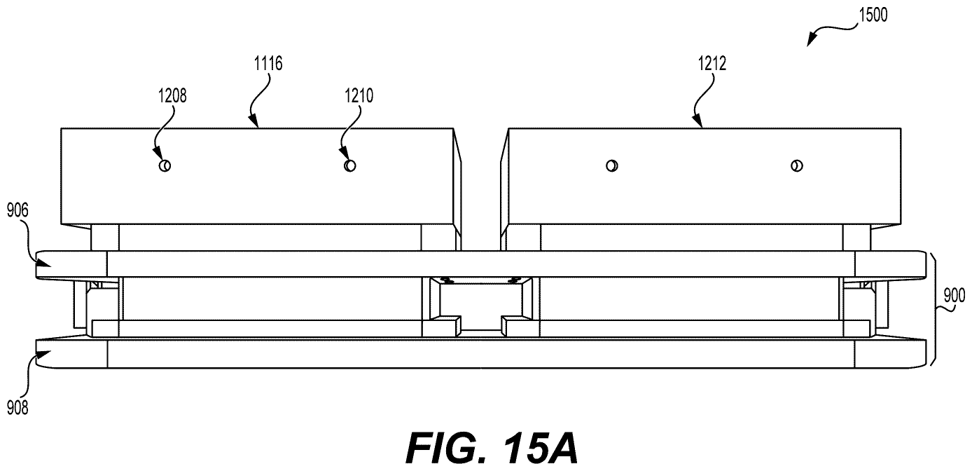

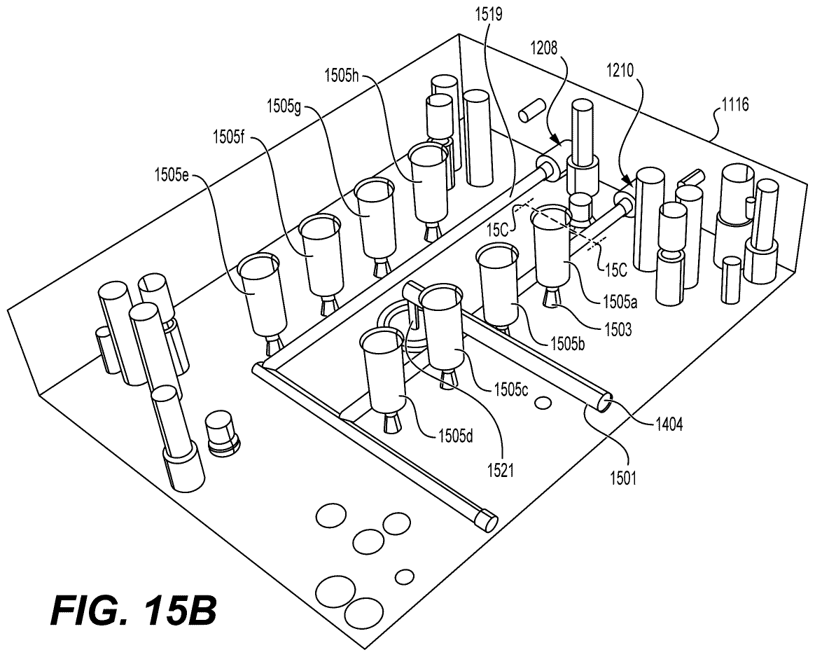

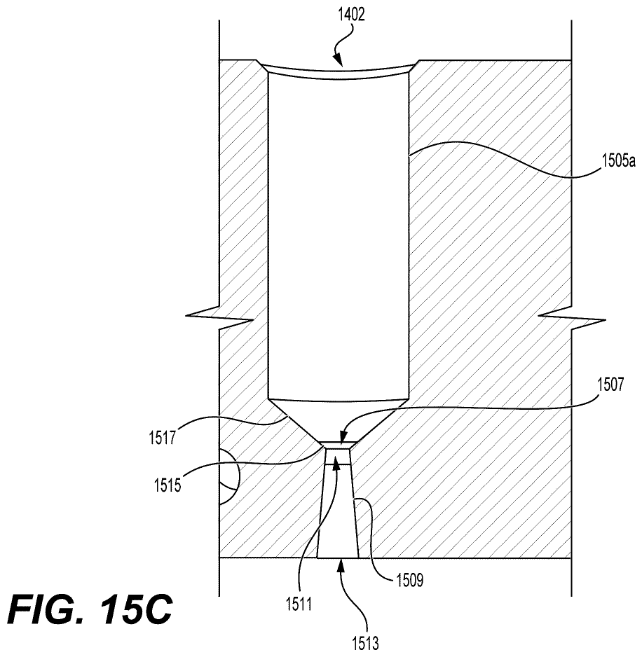

The second hot-runner plate 1212 includes a quantity of nozzle-receiving openings 1405 a-h extending through the hot-runner plate 1212 toward the mold 900. The hot-runner plate 1116 includes a quantity of nozzle-receiving openings 1402 a-h extending through the hot-runner plate 1116 toward the mold 900. Each nozzle-receiving opening 1402a-h and 1405a-h is effective to receive a nozzle (e.g., nozzle 1807 of FIG. 18B) from a manifold, as shown in greater detail at FIGS. 15B and 15C. The nozzle (e.g., nozzle 1807 of FIG. 18B) is effective to fluidly couple a gate (e.g., a gate 1422 of FIG. 14B) of the mold 900 with the injector 312 allowing for a fluid communication of the molten composition from the injector 312 to the mold cavity (e.g., mold cavity 1420 of FIG. 14B).

FIG. 14B depicts a partially exploded view of the tooling assembly 1400 of FIG. 14A showing a second mold plate 1406 separated from a mold ring plate 1408, in accordance with aspects hereof. The second mold plate 1406 includes a perimeter wall 1410 forming a boundary along sides of a mold cavity wall 1412. In addition, the mold ring plate 1408 includes a mold cavity wall 1414 at least partially enclosing a mold-ring cavity 1416, and the mold cavity wall 1414 includes a first perimeter ridge 1418 traversing the perimeter of the mold-ring cavity 1416. When the second mold plate 1406 is layered next to or abuts the mold ring plate 1408, such as when the first mold portion 1401 is assembled, the perimeter wall 1410 nests inside the mold cavity wall 1414 to at least partially enclose a portion of the mold-ring cavity 1416. In addition, the perimeter wall 1410 abuts the first perimeter ridge 1418 to at least partially seal and form a mold cavity 1420.

One aspect of the present disclosure includes a mold system having a universal runner plate (e.g., universal hot-runner plate or universal cold-runner plate) and an array of two or more molds (e.g., first mold portion 1401 and second mold portion 1403 of FIG. 14A), each of which is configured to interface with the universal runner plate and includes a three-dimensional mold-cavity size. Furthermore, the three-dimensional mold-cavity size of a first mold of the array is for a footwear component of a first shoe size, such that the first mold includes a first runner configuration. The three-dimensional mold-cavity size of the second mold of the array is for a footwear component of a second shoe size. In one aspect, the first shoe size and the second shoe size are each in a range of US Men's 3.5 to US Men's 15, or US Men's 5 to US Men's 12, or US Men's 6 to US Men's 11, or US Men's 7 to US Men's 10. For example, the first shoe size might be in a range of US Men's 3.5 to U.S. Men's 8, or US Men's 5 to US Men's 7.5, or US Men's 6 to US Men's 7; and the second shoe size might be in a range of US Men's 8.5 to US Men's 15, or US Men's 9 to US Men's 12, or US Men's 9 to US Men's 10.

FIG. 15A depicts a front view 1500 of the mold 900 and hot-runner plates 1116, 1212 of FIG. 14A, in accordance with aspects hereof. Referring to FIGS. 15B and 15C, some of the walls of the hot-runner plate 1212 are omitted to illustrate some interior components of the hot-runner plate 1212 in more detail. For example, the hot-runner plate 1212 includes eight nozzle-receiving sleeves 1505a- 1505h, each of which receives a respective nozzle (e.g., nozzle 1807 of FIG. 18B) of the injection manifold 1120. Each nozzle-receiving sleeve 1505a-1505h includes a nozzle-receiving opening 1402 a (see FIG. 14A) and a sleeve outlet 1507. The sleeve outlet 1507 includes a perimeter rim 1515 that forms a nozzle seat 1517 against which a tip of the nozzle (e.g., nozzle 1807 of FIG. 18B) biases when then nozzle is fully inserted into the nozzle-receiving sleeve.

The hot-runner plate 1116 also includes hot runners (e.g., 1509) that transport material from each nozzle (e.g., nozzle 1807 of FIG. 18B) after being dispensed. For example, each hot runner (e.g., 1509) includes a hot-runner inlet (e.g., 1511) that fluidly connects with the sleeve outlet (e.g., 1507 in the cross-sectional view of FIG. 15C) and includes a hot-runner outlet 1513. In an aspect of the present disclosure, the hot-runner inlet (e.g., 1511) is spaced apart from the hot-runner outlet (e.g., 1513) by a distance in a range of about 1 cm to about 3 cm. As such, when material is dispersed from the nozzle (e.g., nozzle 1807 of FIG. 18B), a sprue is formed in the hot runner (e.g., 1509), the sprue having a length in a range of about 1 cm to about 3 cm. In an aspect of the present disclosure, this sprue length provides a grasping region at which a tool can grip the sprue for removing solidified material from the runners in the mold (e.g., mold 900 of FIG. 9).

The hot-runner plate 1116 includes various components to help control conditions related to the injection-molding system. For example, the hot-runner plate 1116 includes conditioned-fluid lines 1519 for transporting conditioned fluid throughout the hot-runner plate 1116. The conditioned fluid may be conditioned to include a temperature for maintaining, increasing, or decreasing a temperature of components of the hot-runner plate, including the hot runners (e.g., 1509), the nozzle-receiving sleeves 1505a- 1505h, and the nozzles (e.g., nozzle 1807 of FIG. 18B) when inserted in the sleeves (see also FIG. 12 depicting the inlet 1208 and the outlet 1210 positioned on an exterior wall of the hot-runner plate 1116). As such, when the thermoplastic elastomer composition (e.g., single-phase solution with supercritical fluid as physical foaming agent) is dispensed from a nozzle (e.g., nozzle 1807 of FIG. 18B), the temperature in the hot-runner plate 1116 may be maintained high enough to delay transition of the supercritical fluid to a gas and/or to maintain the polymeric composition in a molten state.

In a further aspect, the hot-runner plate 1116 includes a gas conduit 1501 for fluidly communicating with the gas counter pressure source 226 of FIG. 2 by way of the gas counter pressure port 1404 of FIG. 14A to a gas counter pressure outlet 1521 that is effective to fluidly communicate with a mold (e.g., mold 900 of FIG. 9).

In one aspect of the present disclosure, the hot-runner plate 1116, 1212 is a universal hot-runner plate that is coupled directly to the injection manifold 1120 of FIG. 18A. For example, one or more fasteners may couple the hot-runner plate 1116, 1212 to the injection manifold 1120. Some conventional injection molding systems may, in contrast to the present disclosure, have separate hot-runner plates that each interfaces with a different cold-runner plate (or other plate that is not temperature conditioned) and that are connected and disconnected to the manifold or nozzles in each injection cycle. This aspect of the present disclosure includes a universal hot-runner plate that is mountable to the nozzles and that can interface with an array of different molds, each of which includes a different mold cavity, a different gate scheme, or any combination thereof. For example, the mold cavities may differ in volume and or shape as being used to mold parts of different sized shoes, and the gate scheme may differ by including different gate positions and/or quantities of gates. In aspects, as single gate may service the mold cavity as opposed to a plurality of gates servicing the single mold cavity. In addition, the hot-runner plate 1116 is plumbed with all of the components used to control various aspects of the molding process, including the conditioned-fluid lines 1519 and the gas conduit 1501. Hot-runner plates are often associated with higher costs (e.g., added plumbing for temperature conditioning elements). Among other things, a universal hot-runner plate may reduce costs across multiple sets of molds, since only a single, common hot-runner plate may be used across the multiple sets, as opposed to having to make a hot-runner plate for each mold. In addition, it can reduce costs over time since there are fewer parts to store, maintain, repair, move, handle, etc. Although the figures of this present disclosure illustrate the hot-runner plates 1116 and 1212, which provide an interface between the injector nozzles 1807 and the tooling, in other aspects of this disclosure, universal cold-runner plates or other types of universal runner plates may provide the interface between the injector nozzles 1807 and the tooling.

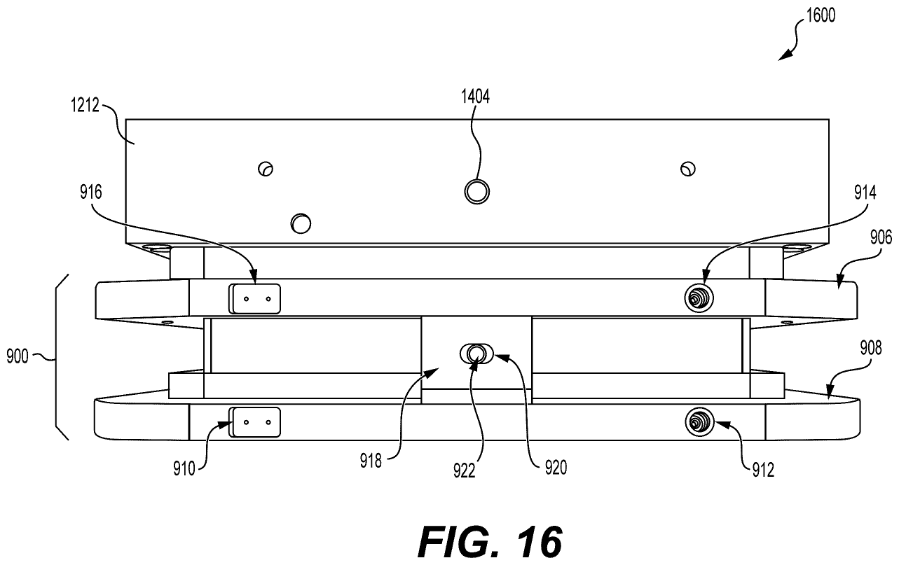

FIG. 16 depicts a side view 1600 of the mold 900 and hot-runner plate 1212 of FIG. 14A, in accordance with aspects hereof. FIG. 17 depicts a bottom plan view 1700 of the mold 900 of FIG. 14A, in accordance with aspects hereof. The first plate-alignment keyway 1704 and the second plate-alignment keyway 1706 are depicted on a bottom surface 1702 of the first carrier plate 908. As previously discussed, the first plate-alignment keyway 1704 and the second plate-alignment keyway 1706 are effective for receiving alignment protrusions from components of the system, such as the temperature conditioning rack 402, the press 1100, and an unloader 2300. These keyways 1704, 1706 ensure alignment, position, and orientation during various processes and in anticipation of future processes (e.g., in preparation to be picked by the end effector with strict dimensional tolerance).

Also depicted is an RFID tag 1708. The RFID tag 1708 is recessed into the bottom surface 1702 preventing interference or collision with other surfaces. The RFID tag 1708 provides is a unique identifier that is associated with the mold (e.g., mold 502 of FIG. 5) such that when the RFID tag 1708 is interrogated, the unique identifier results in the system 200 knowing the location of the mold based on the location of the RFID tag 1708 in the system 200 and/or by which RFID reader (e.g., 438 RFID reader of FIG. 4) identifies the RFID tag 1708.

FIG. 18A depicts a perspective view 1800 of the press 1100 of FIG. 11 aligned with an injector 1806, in accordance with aspects hereof. The injector 1806, which may be referred to as an injection-molding barrel, terminates with a nozzle 1804. The injector 1806 is an example embodiment of the injector 312. The nozzle 1804 is effective to engage with an injector port 1802 of the injection manifold 1120. The injector port 1802 is sized and configured to engage with the nozzle 1804 to form a fluid coupling that allows single-phase solution to remain a single-phase solution as the single-phase solution transfer from the injector 1806 to the injection manifold 1120. The injector port 1802 provides a conduit 1803 through the injection manifold 1120 to the manifold nozzles (e.g., nozzles 1807 of FIG. 18B) that extend through the hot-runner plates 1116, 1212 and form a fluid coupling with the mold 900 of FIG. 13 secured and compressed in the press 1100.

Referring to FIG. 18B, an example of a set of injection nozzles (e.g., 1807) is shown as part of the injection manifold 1120 having exterior walls removed. The injection manifold 1120 includes the injector port 1802 that connects to the nozzle 1804 of the injector 1806. The injection manifold 1120 also includes a series of internal components (not shown) that receive a deposit/shot of thermoplastic elastomer composition from the injector 1806 and divides the shot into a number of deposits for separately distributing through the nozzles (e.g., 1807). The injection manifold 1120 may also include one or more sensors (e.g., thermocouple) (not shown) for monitoring conditions (e.g., temperature, pressure, etc.) of the injection manifold 1120 that may affect the thermoplastic elastomer composition, as well as a manifold temperature conditioning unit 1811 for maintaining, increasing, or decreasing a temperature of the injection manifold 1120. For example, the manifold temperature conditioning unit 1811 may include conditioned-fluid lines 1805 for holding and transporting coolant or heated conditioning fluid. As such, a state of the thermoplastic elastomer composition (e.g., single-phase solution) may be maintained while a deposit is distributed from each nozzle (e.g., 1807) into the hot-runner plates 1116, 1212. For example, the injection manifold 1120 may maintain the thermoplastic elastomer composition at conditions conducive to maintaining the foaming agent in a supercritical-fluid phase and to reducing the likelihood of transition to a gas. In a further aspect, the injection manifold 1120 includes an injector-pin assembly (e.g., 1809) for each nozzle (e.g., 1807), which may selectively insert a pin (or other obstruction) into a tip of each nozzle to impede a flow of material.

In a further aspect of the present disclosure, the nozzles 1807 are arranged in groups of nozzles, including between two and six nozzles. For example, in FIG. 18B, the nozzles 1807 are arranged in four groups of four linearly aligned nozzles, and in other aspects the groups may include two, three, five, or six linearly aligned nozzles. Each group of nozzles is positioned to collectively inject material into a single mold cavity. For example, in one aspect of the present disclosure, each group of four nozzles is configured to inject material into a single mold cavity having a three-dimensional shape of a footwear component (e.g., footwear sole). In one aspect, four nozzles optimizes the available footprint and injection-system real estate operable to distribute material in to the mold cavity having the three-dimensional shape of a footwear sole. That is, the three-dimensional shape of an average size footwear sole includes a length and four nozzles may optimally use that length to evenly distribution shots of material into the mold cavity in a way that each shot foams and solidifies in a desired manner.

In FIG. 18B, the injection manifold 1120 includes sixteen nozzles 1807, each of which is able to be inserted into a respective nozzle-receiving opening (e.g., 1402) of the hot-runner plates 1116 and 1212 depicted in FIG. 14A.

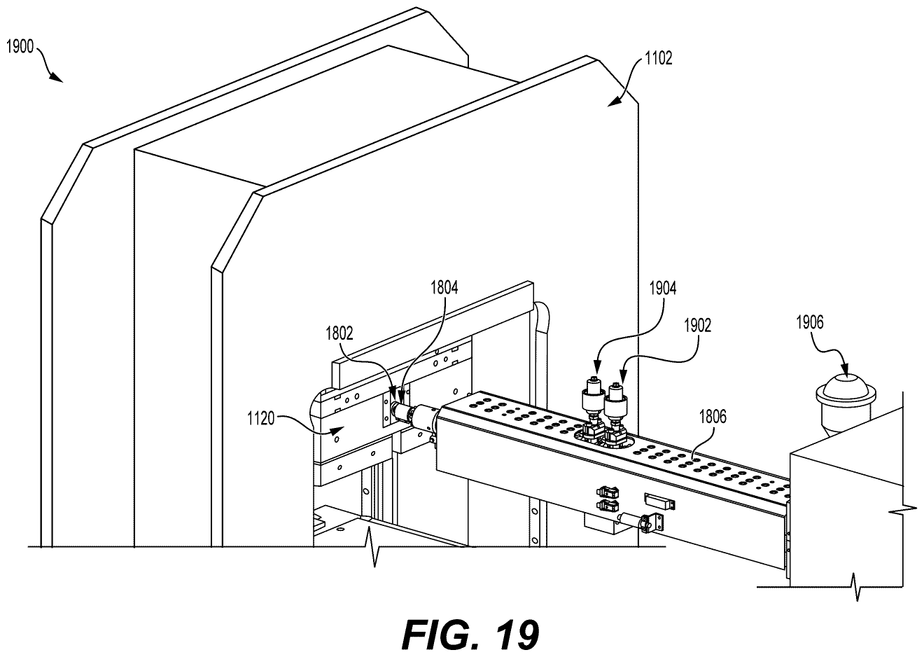

FIG. 19 depicts a perspective view 1900 of the press 1100 and injector 1806 of FIG. 18A paired and in fluid communication, in accordance with aspects hereof. The injector 1806 includes physical foaming agent ports 1902, 1904. The physical foaming agent ports 1902, 1904 provide a coupling location for fluidly coupling the injector 1806 with the dosing source that provides the physical foaming agent, such as a supercritical fluid. The injector 1806 also includes a polymeric composition hopper 1906 that supplies a polymeric composition to the injector 1806 for conversion to a single-phase solution. An injector may include one or more physical foaming agent ports. The physical foaming agent ports, such as physical foaming agent ports 1902, 1904, may be an aperture extending through one or more surfaces, such as surfaces defining a portion of the injector.

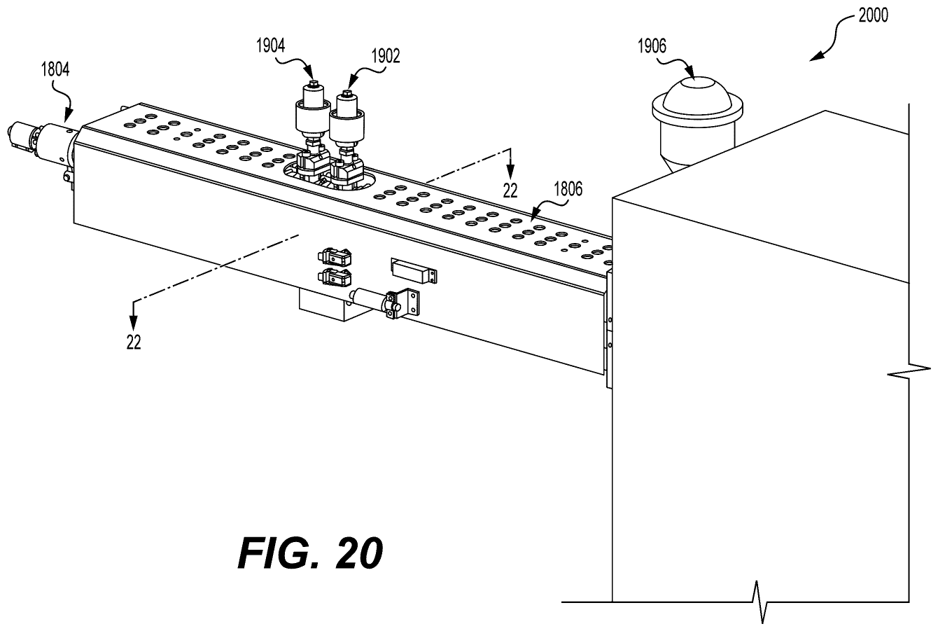

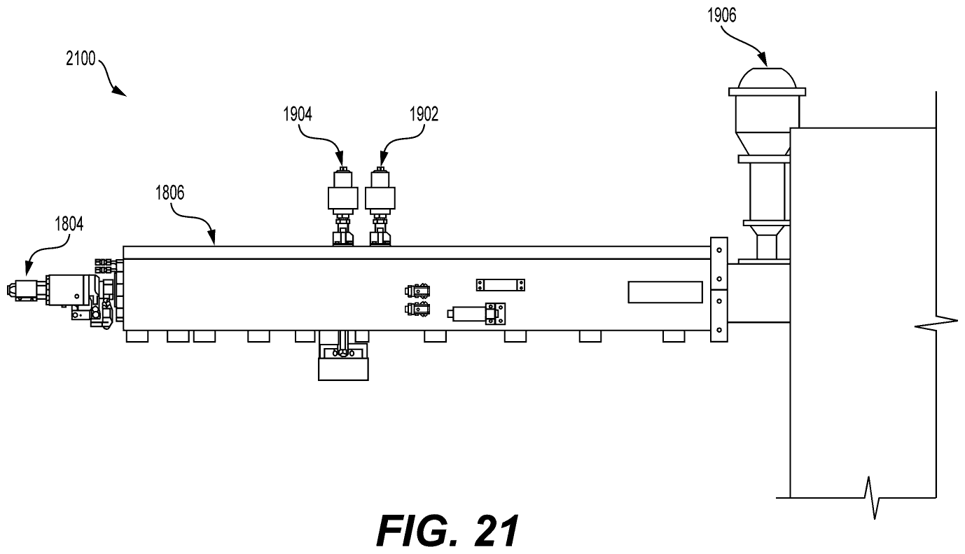

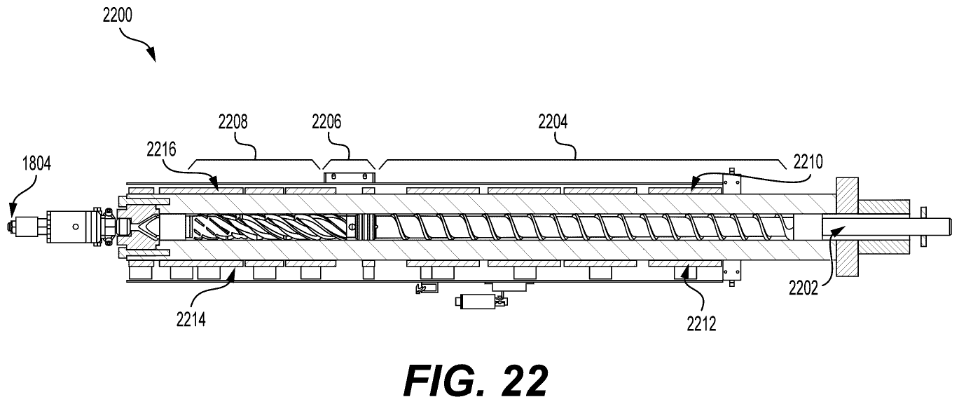

FIG. 20 depicts a perspective view 2000 of the injector 1806 of FIG. 18, in accordance with aspects hereof. A section line 22 -22 is provided in FIG. 20 that will define the cross section of FIG. 22, hereinafter. FIG. 21 depicts a side view 2100 of the injector 1806 of FIG. 20, in accordance with aspects hereof.

FIG. 22 depicts a cross-section view 2200 of the injector 1806 of FIG. 21 along section line 22-22, in accordance with aspects hereof. The injector 1806 is comprised of a screw 2202. The screw 2202 may be rotated by an electric motor, a hydraulic motor, or other rotational mechanisms (not shown). The screw rotation speed affects the melting of the polymeric composition, formation of the single-phase solution, and injection. As such, the screw rotation is from 20 rotations per minute to 120 rotations per minute. The screw 2202 is functional to convey polymeric composition through the injector 1806 and to compress the polymeric composition, which increases the pressure experienced by the polymeric composition within the injector. The injector is also comprised of a quantity of heating elements extending along a length of the injector 1806. A selection of the heating elements are labelled as heating elements 2210, 2212, 2214, 2216. The heating elements are effective to heat the polymeric composition to a molten state. Friction/shear-induced heat generated by the screw 2202 advancing the polymeric composition through the injector 1806 may also contribute to the melting of the polymeric composition. The heating elements may use induction heating, electrical resistive heating, conditioning fluid, or the like.

The injector 1806 is depicted having at least three general regions. A first region 2204 represents a portion of the injector 1806 in which the polymeric composition is heated and compressed. A second region 2206 represents a portion of the injector 1806 in which the physical foaming agent is introduced with the molten polymeric composition. A third region 2208 represent a portion of the injector 1806 in which the physical foaming agent and the molten polymeric composition are integrated to form a single-phase solution. The third region 2208 is also effective, in an example, for metering a volume of single-phase solution for a subsequent injection shot, which will be fluidly communicated through the nozzle 1804 to the manifold, as previously described.

While a specific injector is depicted and described, the injector 1806 is a non-limiting example. It is contemplated within the scope of the system and methods provided herein that an alternative injector configuration, arrangement, and/or structure may be implemented while staying within the contemplated scope herein.

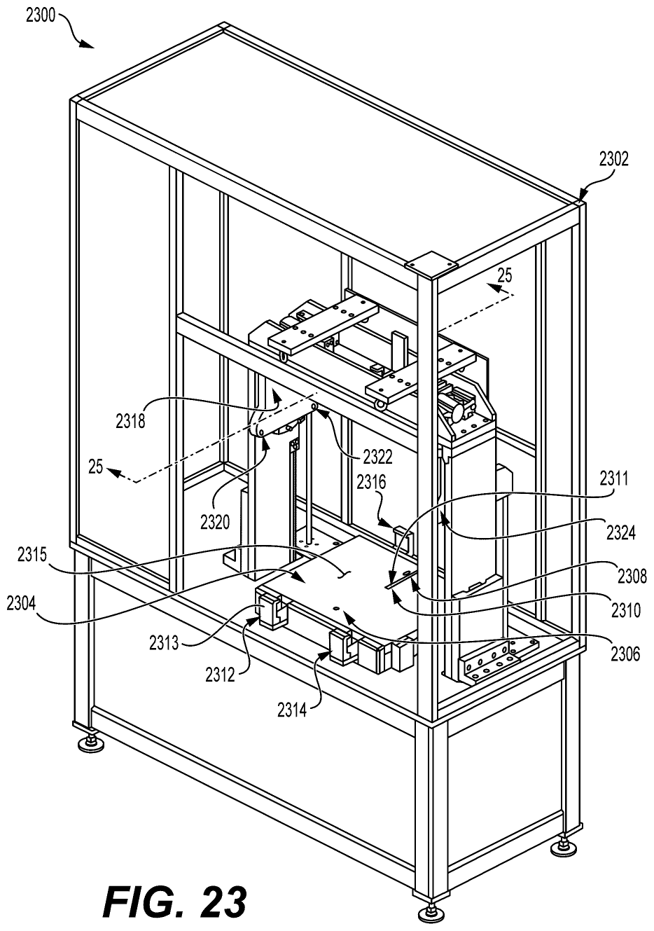

FIG. 23 depicts a perspective view of an unloader 2300, in accordance with aspects hereof. The unloader comprises a frame 2302, an unloader plate 2304, a first unloader arm 2318, a second unloader arm 2324, an unloader lock 2313 having finger 2312, 2314, 2316, and an unloader plate 2304. The unloader plate comprises a first protrusion 2308, a second protrusion 2306, and a recess 2310 containing an RFID reader 2311.

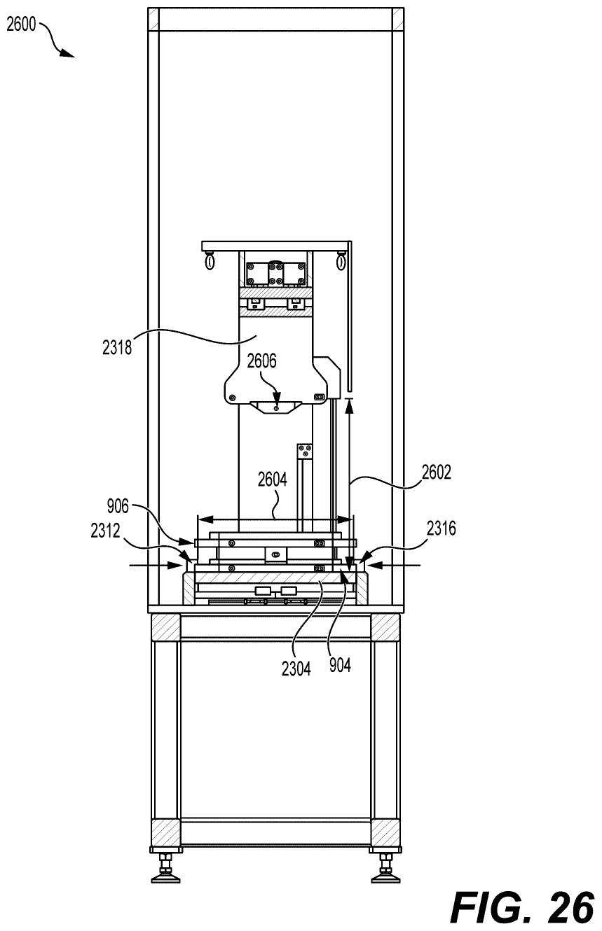

The unloader 2300 is effective to open tooling (e.g., mold 900 shown in FIG. 26) for the unloading of the foamed article contained in a cavity (e.g., cavity 1420 of FIG. 14B) of the tooling. The unloader 2300 secures the tooling to the unloader plate 2304 by sliding the unloader lock 2313 having the fingers 2312, 2314, 2316 over a portion of the tooling, such as the first carrier plate of the mold 900 of FIG. 9. The unloader lock 2313 is able to transition between the unlocked configuration and the locked configuration by sliding the fingers 2312, 2314, 2316 in a plane parallel with a top surface 2315 of the unloader plate 2304. After securing the tooling to the unloader plate 2304, the first unloader arm 2318 and the second unloader arm 2324 can engage with another portion of the tooling, such as the second carrier plate 906 of the mold 900 of FIG. 9. The engagement is achieved through a first protrusion 2320 extending outwardly from the first unloader arm 2318 toward the second unloader arm 2324 and a second protrusion 2322 extending outwardly from the first unloader arm 2318 toward the second unloader arm 2324. The first protrusion 2320 is configured to be received in a keyway, such as the first plate-opening keyway 914 of FIG. 10 and the second protrusion 2322 is configured to be received in a keyway, such as the second plate-opening keyway 916 of FIG. 10.

The first protrusion 2320 is asymmetrical with respect to the second protrusion 2322 in one or more characteristics. The characteristics include, but are not limited to, the protrusion length, protrusion cross section shape, protrusion position, protrusion size, and any combination thereof. Similarly, a third protrusion extending from the second unloader arm 2324 is asymmetrical with respect to a fourth protrusion that is also extending from the second unloader arm 2324 in one or more characteristics. The characteristics include, but are not limited to the protrusion length, protrusion cross section shape, protrusion position, protrusion size, and any combination thereof. The first protrusion and the third protrusion are symmetrical, in an example in at least one characteristic. The second protrusion and the fourth protrusion are symmetrical, in an example, in at least one characteristic.

The first unloader arm 2318 and the second unloader arm 2324 slideably position between an open configuration with a first distance between the first unloader arm 2318 and the second unloader arm 2324 and a closed configuration with a second distance between the first unloader arm 2318 and the second unloader arm 2324. This directional movement, which is in a horizontal manner as depicted, is in disagreement. For example, as the first unloader arm 2318 moves left, the second unloader arm 2324 moves right, which represents an opening configuration. Similarly, as the first unloader arm 2318 moves right, the second unloader arm 2324 moves left, which represents a closing configuration. The slideable motion may be achieved through a powered actuator, such as an electric linear actuator, a pneumatic actuator, a hydraulic actuator, or other movement mechanisms (not shown).

The first unloader arm 2318 and the second unloader arm 2324 are also structured to move in agreement in an alternative direction, such as the vertical direction as depicted in FIG. 23. For example, as the first unloader arm 2318 moves up, the second unloader arm 2324 also moves up, which represents a lifting configuration. Similarly, as the first unloader arm 2318 moves down, the second unloader arm 2324 also moves down, which represents a closing configuration. The agreement motion may be achieved through a powered actuator, such as an electric linear actuator, a pneumatic actuator, a hydraulic actuator, or other movement mechanisms. Therefore, the first unloader arm 2318 and the second unloader arm 2324 are effective to move in a first direction in agreement with each other and to move in a transverse direction in disagreement with each other.

FIG. 24 depicts a side view 2400 of the unloader 2300 of FIG. 23, in accordance with aspects hereof. FIG. 25 depicts a cross-section view of the unloader 2300 of FIG. 24 in a first configuration 2500, in accordance with aspects hereof.

Depicted in FIG. 25 is a first vertical distance 2502 between the first unloader arm 2318 and the unloader plate 2304 and a first horizontal distance 2504 between the pair of fingers 2312, 2316. This first configuration 2500 represents a lifted configuration of the unloading arms and an open configuration of the unloader lock. FIG. 26 depicts a cross-section view of the unloader 2300 of FIG. 24 in a second configuration 2600 with the mold 900, in accordance with aspects hereof. Depicted in FIG. 26 is a second vertical distance 2602 between the first unloader arm 2318 and the unloader plate 2304 and a second horizontal distance 2604 between the pair of fingers 2312, 2316. This second configuration 2600 represents a closing configuration of the first unloader arm 2318 and the second unloader arm 2324 and a locked configuration of the unloader lock 2313. In the locked configuration the pair of fingers 2312, 2316 engage with and secure the first carrier plate 908 of the mold 900. The engagement of the pair of fingers 2312, 2316 secures the first carrier plate 908 to the unloader plate 2304, resists an upward force exerted by the first unloader arm 2318 and the second unloader arm 2324 as they engage with the second carrier plate 906, and lift the second carrier plate 906. This lifting action separates the second carrier plate 906 from the first carrier plate 908, which allows access to an internal volume of the mold cavity such that the foamed article may be removed. Therefore, it is contemplated that the first unloader arm 2318 and the second unloader arm 2324 in their agreement direction of motion are configured to move through at least three positions. The first position is when the mold is closed, a second position is with the mold partially opened to remove scrap material from the runner system of the mold, and a third position having the mold opened a greater extent such that the foamed article may be removed from within the mold cavity. It is contemplated that a delay or cessation of movement for a fixed time from 1 second to 120 seconds is provided between the second position and the third position transition. This intentional delay allows for an automated removal, such as by a supplemental robot, of the scrap, in an example.

The first unloader arm 2318 also comprises a key 2606 extending outwardly from the first unloader arm 2318 toward the second unloader arm 2324. The key 2606 is a protrusion that engages with the biased pin 922 of FIG. 10 that is biased into a locked configuration. The second unloader arm 2324 also comprises a key 2607 (as best seen in FIG. 24) extending outwardly from the second unloader arm 2324 toward the first unloader arm 2318. The key 2607 is a protrusion that engages with the biased pin 922 of FIG. 10 that is biased into a locked configuration.

As the first unloader arm 2318 and the second unloader arm 2324 move in disagreement with each other, each of the first unloader arm 2318 and the second unloader arm 2324 comprises a key, such as the key 2606 and the key 2607 respectively, that engage with respective biased pins (e.g., biased pin 922 of FIG. 10) in respective tooling latch assemblies (e.g., tooling latch assembly 918 of FIG. 10). As the first unloader arm 2318 and the second unloader arm 2324 converge, their respective keys (i.e., the key 2606 and the key 2607) engage with the tooling latch assemblies to release the mechanical lock caused by the biases pins. During the unlocking of the tooling latch assemblies (e.g., tooling latch assembly 918 of FIG. 10) by the unloader 2300, it is contemplated that the unloader 2300, such as through the unloading arms 2318, 2324, compresses the tooling to relieve a shear pressure that is exerted on the biased pin (e.g., biased pin 922 of FIG. 10) by the second portion of the tooling latch assembly interacting with the biased pin. The compression of the tooling by the unloader reduces the interaction of the second portion of the tooling latch assembly with the biased pin in the locked configuration to allow the converging force of the unloader arms to compress the biased pin(s) inwardly and out of the second portion of the tooling latch assembly.

While a specific unloader is depicted and described, the unloader 2300 is a non-limiting example. It is contemplated within the scope of the system and methods provided herein that an alternative unloader configuration, arrangement, and/or structure might be implemented while staying within the contemplated scope herein.

Also disclosed are methods for making a foam article, the method comprising: forming a mixture of molten polymeric material and a blowing agent, wherein the polymeric material comprises a disclosed thermoplastic copolyester elastomer; injecting the mixture into a mold cavity; foaming the molten polymeric material, thereby forming a foamed molten polymeric material; solidifying the foamed molten polymeric material, thereby forming a foam article having a microcellular foam structure; and removing the foam article from the mold cavity; wherein the mixture has an injection temperature; and wherein the injection temperature is from about the melting temperature of the thermoplastic copolyester elastomer to about 50 degrees C. above the tail temperature of the thermoplastic copolyester elastomer.

Also disclosed are methods for making a foam article, the method comprising: forming a mixture of molten polymeric material and a blowing agent, wherein the polymeric material comprises a disclosed thermoplastic copolyester elastomer; injecting the mixture into a mold cavity; foaming the molten polymeric material, thereby forming a foamed molten polymeric material; solidifying the foamed molten polymeric material, thereby forming a foam article having a microcellular foam structure; and removing the foam article from the mold cavity; wherein the foaming occurs at a foaming temperature; and wherein the foaming temperature is from about the melting temperature of the thermoplastic copolyester elastomer to about 50 degrees C. above the tail temperature of the thermoplastic copolyester elastomer.

Dynamic scanning calorimetry (DSC) is used to determine the melting temperature and the tail temperature of a thermoplastic copolyester elastomer, and an exemplary method is described herein below in the Examples. Briefly, 10-30 mg pieces of undried resin pellets are cycled from −90 degrees C. to 225 degrees C. at 20 degrees C./min and cooled to −90° C. at 10° C./min. In some instances, experiments are run using a heat-cool-heat profile with a ramp rate of 10 degrees C. per min, minimum temperature of 0 degrees C. and maximum temperature of 250 degrees C. Analyses should be determined in duplicate. The Tm and Tg values are recorded from the second cycle. The melt “peak” is identified as the local maximum of the second heating cycle. If there is more than one peak in the DSC curve, the peak occurring at hotter temperatures is chosen as the temperature reference. The tail is identified as the intersection of the tangent of the line of the higher temperature side of the melt peak with the extrapolated baseline.

For example, the disclosed foamed polymeric materials can be prepared using a suitable extruder. An extruder (e.g., single or twin screw) can be used to provide a composition. The extruder can have a motor to turn a screw inside the extruder. Extruder may be a single screw or twin screws made of individual elements of various sizes and pitches appropriate for mixing or kneading the specific materials used. In some examples, the extruder has a twin screw.

The various components that make up the compositions used to form the thermoplastic copolyester elastomer foam of the various examples described herein are added into the extruder through one or more port. The various components can be added as a melt or as appropriately-sized solid particles, for example chips or pellets, that are melted in section as they are mixed in the barrel of the extruder. The contents of the extruder can be heated to melt the composition. A supercritical fluid can be added into the melt as a physical blowing agent. In particular examples, the thermoplastic copolyester elastomer foam is prepared by using a physical blowing agent which foams the composition after it exits the extruder, and the thermoplastic copolyester elastomer foam is thus substantially free of a chemical blowing agent or decomposition product thereof.

In some examples, the compositions can be added as a melt at a temperature close to or at a temperature that causes ionic crosslinks between polymer chains to dissociate. At lower temperatures the ionic moieties can reform or reassociate. Due to the ionic crosslinking, the extent to which the compositions are crosslinked during processing can be controlled by controlling the temperature; by causing a temperature reduction at a desired point to increase crosslinking, which results in an increase in the modulus or viscosity of the molten resin as the ionic moieties reassociate.

If a chemical blowing agent is used, the processing (melting) temperature used can be sufficiently below the temperature that would trigger the blowing agent. In order to foam the composition, the temperature near the exit of the extruder can be increased to a temperature close to or at the triggering temperature of a chemical blowing agent, thereby producing a chemically foamed thermoplastic copolyester elastomer foam as the composition exits the extruder (e.g., as the composition is injected into an injection mold).

Alternatively or in addition, a physical blowing agent can be used for foam the composition to form a physically foamed thermoplastic copolyester elastomer foam, or a physically and chemically foamed thermoplastic copolyester elastomer foam. For example, a supercritical fluid such as supercritical carbon dioxide or supercritical nitrogen can be mixed with the molten polymeric composition in the barrel of the extruder. As the mixture of the molten composition comprising one or more thermoplastic copolyester elastomers and a supercritical fluid exits the extruder, the pressure drop between the higher pressure in the extruder and the lower pressure outside the extruder causes the supercritical fluid to transition to the gas phase and foam the molten polymeric composition.

Various examples include methods of manufacturing an article of footwear or components for an article of footwear. In some examples, the methods of manufacturing an article of footwear include injection molding a composition to form a thermoplastic copolyester elastomer foam described herein to produce a foam article or component of an article, such as an article of footwear. The article or component of an article can be a midsole or a component of a midsole, and the method can include providing an upper and an outsole for an article of footwear; and combining the midsole or midsole component, the upper, and the outsole to make an article of footwear. In some examples, the method of manufacturing the article of footwear includes combining an article comprising a thermoplastic copolyester elastomer foam, an upper, and an outsole to make an article of footwear.

In some examples, the thermoplastic copolyester elastomer foams of the various examples described herein are made using a process that involves impregnating a polymeric composition (e.g., at or above a softening temperature of the composition) with a physical blowing agent at a first concentration or first pressure. As used herein, the term “impregnating” generally means dissolving or suspending a physical blowing agent in a composition. The impregnated composition can then be foamed, or can be cooled (when applicable) and re-softened (when applicable) for blowing at a later time.

In some instances, the impregnated composition is foamed by reducing the solubility of the physical blowing agent in the polymer matrix through pressure or temperature changes. The reduction in solubility of the physical blowing agent can release additional amounts (e.g., to create a secondary expansion of an originally-formed microcell in the composition) of the impregnated physical blowing agent from the composition, to further blow the composition, forming a foam composition (e.g., a foam composition having a microcellular structure).

In addition to injection molding, the thermoplastic copolyester elastomer foam of the present disclosure can be foamed and molded using various processes known in the art. For example, the thermoplastic copolyester elastomer foam can be formed into slab foam, filament or strand foams, particulate (e.g., bead) foams of various shapes and sizes, etc. These various forms of foam can then be used in different ways. For example, like injection molded foam, slab foam and filament or strand foam can be used directly as a finished foam article, or can be shaped (e.g., cut, buffed, or trimmed) to form a finished foam article, or can be compression molded to form a finished foam article. Optionally, the thermoplastic copolyester elastomer foam can be subjected to annealing processes as part of forming the finished foam article. Pellets of the compositions can be used to form individual particulate thermoplastic copolyester elastomer foams, or can be foamed and molded to form unitary molded foam articles composed of individual portions of foam affixed to each other.

The thermoplastic copolyester elastomer foams of the various examples described herein may be further shaped or molded by any of the methods known for forming articles from thermoplastic materials. Optionally, the thermoplastic copolyester elastomer foams of the present disclosure which have been foamed using any suitable blowing process (e.g., blowing using a physical and/or chemical blowing agent), including by injection molding using only a physical blowing agent, can then be compression molded to form a compression molded foam.

In some examples, the thermoplastic copolyester elastomer foam of the present disclosure can be prepared by a process comprising (i) softening a composition (e.g., by heating at a first temperature at or above a softening temperature of the composition); (ii) simultaneously or sequentially with the softening (when applicable), contacting the composition with a first concentration or first pressure of a physical blowing agent sufficient to drive an amount of the physical blowing agent into the composition or combine the physical blowing agent with the composition; (iii) changing the concentration or pressure (e.g., decreasing the pressure or concentration) of the physical blowing agent to a second concentration or second pressure that is effective to foam the composition, thereby forming a thermoplastic copolyester elastomer foam (e.g., a thermoplastic copolyester elastomer foam having a microcellular structure); and, (iv) following the changing, cooling (when applicable) the thermoplastic copolyester elastomer foam to (e.g., cooling to a temperature below the softening temperature of the composition), to form a solidified thermoplastic copolyester elastomer foam.

In other examples, the thermoplastic copolyester elastomer foam of the present disclosure is prepared by (i) contacting (e.g., dissolving or suspending) the composition with a first concentration of a chemical blowing agent, in some examples, at or above a softening temperature of the composition (ii) triggering the chemical blowing agent to foam the composition, thereby forming a thermoplastic copolyester elastomer foam (e.g., a thermoplastic copolyester elastomer foam having a microcellular structure); and, (iii) following the triggering, in some examples, cooling the thermoplastic copolyester elastomer foam to, e.g., a temperature below its softening temperature, to form a solidified thermoplastic copolyester elastomer foam. In some examples, the “triggering” of the chemical blowing agent is performed by any suitable method, including heating the composition comprising a concentration of the chemical blowing agent to a temperature sufficient to “trigger” the chemical blowing agent, wherein the concentration of the chemical blowing agent is effective to foam the composition, thereby forming a thermoplastic copolyester elastomer foam (e.g., a thermoplastic copolyester elastomer foam having a microcellular structure). In some examples, the contacting comprises contacting at a pressure of from about 10 MPa to about 100 MPa (e.g., from about 30 MPa to about 100 MPa, about 20 MPa to about 80 MPa, about 30 MPa to about 60 MPa or about 40 MPa to about 70 MPa).

Chemical foaming agents may be endothermic or exothermic, which refers to a type of decomposition they undergo to produce the gas for foaming. The decomposition may be a result of thermal energy in the system. Endothermic foaming agents absorb energy and typically release a gas, such as carbon dioxide, upon decomposition. Exothermic foaming agents release energy and generate a gas, such as nitrogen, when decomposed. Regardless of the chemical foaming agent used, thermal variables of the polymer composition being molded and thermal variables of the foaming agent to be decomposed are coupled together such that process parameters are selected so that the polymer can be molded and the foaming agent can decompose at an appropriate phase of the molding operation.

In a further example, the disclosed foamed polymeric materials and articles can be prepared by using a system providing for decreased pressure losses across the system as well as to control (e.g., deliberately increase or decrease) the elongation, apparent shear, and/or zero shear viscosities of the molten polymeric material that is flowed into the mold. For example, the method includes flowing a molten polymeric material into a shot tuning chamber from an upstream device and adjusting a temperature, a pressure, or both, within the shot tuning chamber to create a tuned molten polymeric material. The method additionally includes flowing the tuned molten polymeric material into a mold cavity from the shot tuning chamber. It will be appreciated that fine-tuning the temperature of and/or pressure applied to the molten polymeric material enables the system to have a desired impact on the physical and mechanical properties of the molded article. In particular, the temperature of the molten polymeric material may be controlled to achieve a desired range of shear/extensional viscosities, which reduces (e.g., substantially eliminates) uncontrolled bubble growth and/or nucleation. In one example, the method may also include adjusting (e.g., increasing and/or decreasing) a pressure in the mold cavity via a gas counter pressure (GCP) assembly prior to or while the molten polymeric material is flowed from the shot tuning chamber into the mold cavity. In such an example, the molten polymeric material may be flowed into the mold cavity at pressures well above ambient pressure. Furthermore, GCP may be introduced into the mold cavity to control nucleation and bubble growth during polymer foaming as well as increase surface quality of the molded article. Nucleation and bubble growth control enhances cell density uniformity and mechanical properties of the molded polymeric material. In some examples, the improvement in cell density homogeneity may be particularly beneficial in articles having low densities such as articles that have a density less than or equal to 0.3 grams per cubic centimeter and/or in articles having large dimensions such as articles having a thickness that is ≥1.0 cm, for instance.

In various aspects, the system can include a shot tuning chamber configured to receive a molten polymeric material from an upstream device. The shot tuning chamber is also configured to adjust one or more of a temperature of and a pressure applied to the molten polymeric material to create an adjusted molten polymeric material and to dispense the adjusted molten polymeric material. In this way, the system can selectively adjust tuning chamber temperature and/or pressure to achieve desired properties, as previously mentioned. In one example, the system may further include an adjustable mold runner configured to regulate fluidic communication between the shot tuning chamber and a mold cavity in a mold. In another example, the system can further include a GCP assembly coupled to the mold cavity and configured to regulate an amount of counter pressure gas flow into and out of the mold cavity. Providing GCP adjustment allows for additional tuning of the polymeric material as it enters and cools in the mold.

Alternatively, the disclosed foamed polymeric materials and articles can be prepared using methods and systems such as a method for molding a single-phase solution comprised of a polymer composition and a gas. The polymer composition and the gas are maintained under pressure during the molding operation to prevent a cellular structure from being formed by the dissolved gas in the polymer composition coming out of solution. The mold cavity in which the single-phase solution is introduced for molding purposes is pressurized to a mold pressure that is sufficient to maintain the single-phase solution as a single-phase solution as the mold cavity is filled. Subsequent to filling the mold cavity with the single-phase solution under pressure, the resulting article may solidify entrapping the compressed gas, or the article may be exposed to a reduction in pressure causing the entrapped gas to form a microcellular structure.

The method can include forming the single-phase solution, such as through introduction of pressurized gas with a polymer composition that is melted, e.g., from about the Tm up to about 50 degrees C. above the Ttail of the thermoplastic copolyester elastomer as described elsewhere, in an injection molding apparatus's barrel (e.g., screw) that is effective to mix and dissolve the gas with the polymer composition while under pressure. The method continues with pressurizing a mold cavity of a mold above atmospheric pressure to a mold pressure. Atmospheric pressure is a pressure of the environment in which the mold cavity is exposed (e.g., general environment pressure). The mold pressure is at least a pressure to maintain the single-phase solution as a single single-phase. The method further includes injecting the single-phase solution into the pressurized mold cavity. The method also includes maintaining at least the mold pressure in the mold cavity during the injecting of the single-phase solution. As a result, the pressure in the mold cavity prevents the gas from coming out of solution to form a two-phase mixture (e.g., foaming) upon exit from the injection molding apparatus. As the pressure is maintained, premature foaming as the polymer composition is injected from the injection molding apparatus is avoided to allow a decoupling of process parameters associated with the foaming agent and the polymer composition.

In another example, a molding system can be utilized to prepare the disclosed foamed polymeric materials that includes a device configured to receive a polymeric material and heat the polymeric material to form a molten polymeric material. The molding system additionally includes a shot tuning chamber configured to receive the molten polymeric material from the device and adjust a temperature of or a pressure applied to the molten polymeric material. The molding system also includes an adjustable mold runner configured to regulate the flow of the molten polymeric material between the shot tuning chamber and a mold cavity. In one example, the device may be an injection device or an extrusion device. The molding system allows the characteristics of the polymeric material to be adapted to achieve desired end-use goals.

In some aspects, the present disclosure is directed to a compression molded thermoplastic copolyester elastomer foam, and to a method of forming compression molded thermoplastic copolyester elastomer foam for, among other applications, articles of footwear or athletic equipment. In some examples, the method can be a process comprising providing (e.g., preparing) a thermoplastic copolyester elastomer foam preform and then compression molding the thermoplastic copolyester elastomer foam preform to form a compression molded thermoplastic copolyester elastomer foam. For example, the thermoplastic copolyester elastomer foam can be compression molded by placing the thermoplastic copolyester elastomer foam preform in a compression mold having a height less than the initial height of the thermoplastic copolyester elastomer foam preform and closing the mold, thereby compressing the thermoplastic copolyester elastomer foam preform to the height of the mold. Simultaneously or sequentially with the compressing, the thermoplastic copolyester elastomer foam preform can be heated in the closed compression mold. During the compression molding, the temperature of at least a portion of the thermoplastic copolyester elastomer foam preform in the closed mold can be raised to a temperature within ±30 degrees C. of the softening temperature of the composition. The temperature can be raised by heating the closed mold. Following the raising of the temperature, while the thermoplastic copolyester elastomer foam preform remains closed in the compression mold, the temperature of at least a portion of the thermoplastic copolyester elastomer foam preform can be lowered. The temperature can be lowered by cooling the closed mold. The lowering can lower the temperature of at least a portion of the thermoplastic copolyester elastomer foam preform to a temperature at least 35 degrees C. below the softening temperature of the composition, thereby forming the compression molded thermoplastic copolyester elastomer foam. Following the cooling, the compression mold can be opened, and the compression molded thermoplastic copolyester elastomer foam can be removed from the compression mold.

Examples contemplated herein are directed to methods of manufacturing articles of footwear or athletic equipment. For example, the method can comprise providing components such as midsoles and inserts of an article of footwear in accordance with the present disclosure, and combining the component with a footwear upper and an outsole to form the article of footwear.

One method of making compression molded thermoplastic copolyester elastomer foam articles such as midsoles and inserts or components of articles such as components of midsoles or components of inserts described herein comprises forming a thermoplastic copolyester elastomer foam preform and compression molding the thermoplastic copolyester elastomer foam preform to make a compression molded thermoplastic copolyester elastomer foam. In some examples, the foam preforms of the various examples described herein are obtained by blowing the composition by about 150 percent to about 240 percent (e.g., from about 150 percent to about 220 percent; about 150 percent to about 200 percent, about 175 percent to about 225 percent, about 180 percent to about 230 percent or about 160 percent to about 240 percent) in at least one dimension (e.g., the vertical dimension) using a blowing agent. In some examples, the blown composition can be compression molded to about 120 percent to about 200 percent (e.g., from about 120 percent to about 180 percent; about 130 percent to about 190 percent; about 150 percent to about 200 percent; or about 160 percent to about 190 percent) in at least one dimension.

Thus for example, if the foaming of the composition is about 200 percent, the blown composition can be compression molded by a net 20 percent by compression molding to about 180 percent. In another example, if the composition is blown into a 20 millimeter (height)×10 centimeter (width)×5 centimeter (depth) slab (wherein hereinafter, “mm” will be used to indicate millimeter and “cm” will be used to indicate centimeter), and the slab is compression molded in the height direction by 20 percent, the compression molded slab would have the dimensions 18 mm (height)×10 cm (width)×5 cm (depth). In some examples, the compression molding is substantially maintained.

In some examples, the thermoplastic copolyester elastomer foam is made using a process that involves impregnating a composition (e.g., at or above a softening temperature of the composition) with a physical blowing agent at a first concentration or first pressure. The impregnated composition can then be foamed, or can be cooled (when applicable) and re-softened (when applicable) for blowing at a later time. In some instances, the impregnated composition is foamed by reducing the temperature or pressure, impacting the solubility of the physical blowing agent. The reduction in solubility of the physical blowing agent can release additional amounts of the impregnated physical blowing agent from the composition to further blow the composition forming a thermoplastic copolyester elastomer foam (e.g., a thermoplastic copolyester elastomer foam having a microcellular structure).

In some examples, the compression molding process is conducted by heating the thermoplastic copolyester elastomer foam preform in a closed compression mold. The thermoplastic copolyester elastomer foam preform is heated to a temperature close to its softening temperature, to allow the foam to retain the shape of the compression mold. For example, the foam preform can be heated to a temperature within ±30 degrees C. of its softening temperature, or within ±20 degrees C. of its softening temperature, or within ±10 degrees C. of its softening temperature, or within ±5 degrees C. of its softening temperature. For example, the thermoplastic copolyester elastomer foam preform can be heated to a temperature of from about 100 degrees C. to about 250 degrees C., or of from about 140 degrees C. to about 220 degrees C., or of from about 100 degrees C. to about 150 degrees C., or of from about 130 degrees C. to about 150 degrees C.

The material used to form the compression mold can be any material which can withstand the temperatures used during the process, such as machined metals, including aluminum. The compression mold can be made using two pieces, such as a top and a bottom mold. Depending on the shape of the foam component to be molded, a multiple-piece mold may be used in order to more easily release the compression molded foam from the mold.

The injection molded thermoplastic copolyester elastomer foam can have a closed skin. A closed skin can also be formed by compression molding a thermoplastic copolyester elastomer foam preform in a compression mold. However, care should be taken during the compression molding not to subject the thermoplastic copolyester elastomer foam preform to conditions such that more than a desired amount of the closed cell structures of the foam collapse. One way to avoid collapsing more than a desired amount of the closed cell structures is to control the temperature of the thermoplastic copolyester elastomer foam during the compression molding process, for example, by controlling the temperature of the mold. For example, during the compression molding step, the heating of the thermoplastic copolyester elastomer foam preform in the compression mold can be conducted for time of from 100 seconds to 1,000 seconds, or of from 150 seconds to 700 seconds.

Once the thermoplastic copolyester elastomer foam has been heated in the compression mold at the appropriate temperature for the desired length of time to soften the thermoplastic copolyester elastomer foam to the desired level, the softened preform is cooled, for example, to a temperature at least 35 degrees C. below its softening temperature, or at least 50 degrees C. below its softening temperature, or at least 80 degrees C. below its softening temperature, to re-solidify the softened foam, thereby forming the compression molded foam. Once cooled, the compression molded thermoplastic copolyester elastomer foam is removed from the compression mold. Following the heating, the cooling of the foam preform in the compression mold can be conducted for a time of from 50 to 1,000 seconds, or for a time of from 100 to 400 seconds.

In the thermoplastic copolyester elastomer foam of the present disclosure, the composition comprising one or more thermoplastic copolyester elastomers has a foam structure with a density of about 0.7 grams per cubic centimeter, 0.5 grams per cubic centimeter, 0.4 grams per cubic centimeter, 0.3 grams per cubic centimeter, or less. The thermoplastic copolyester elastomer foam has a density of about 0.1 grams per cubic centimeter to about 0.22 grams per cubic centimeter, about 0.2 grams per cubic centimeter to about 0.35 grams per cubic centimeter, or about 0.1 grams per cubic centimeter to about 0.35 grams per cubic centimeter. The thermoplastic copolyester elastomer foam can be foamed using any one of the methods described above. The foams and components of the present disclosure can have a density of from 0.02 grams per cubic centimeter to 0.22 grams per cubic centimeter, or of from 0.03 grams per cubic centimeter to 0.12 grams per cubic centimeter, or of from 0.04 grams per cubic centimeter to 0.10 grams per cubic centimeter, or from 0.11 grams per cubic centimeter to 0.12 grams per cubic centimeter, or from 0.10 grams per cubic centimeter to 0.12 grams per cubic centimeter, from 0.15 grams per cubic centimeter to 0.2 grams per cubic centimeter; 0.15 grams per cubic centimeter to 0.30 grams per cubic centimeter. Alternatively or in addition, the foam preform can have a density of from 0.01 grams per cubic centimeter to 0.10 grams per cubic centimeter, or of from 0.02 grams per cubic centimeter to 0.08 grams per cubic centimeter, or of from 0.03 grams per cubic centimeter to 0.06 grams per cubic centimeter; 0.08 grams per cubic centimeter to 0.15 grams per cubic centimeter; or from 0.10 grams per cubic centimeter to 0.12 grams per cubic centimeter. For example, the density of the compression molded foam component can be from or from 0.15 grams per cubic centimeter to 0.2 grams per cubic centimeter, and the density of the foam preform can be from 0.10 grams per cubic centimeter to 0.12 grams per cubic centimeter. The thermoplastic copolyester elastomer foam can be included in components of articles of footwear as described above, for example a sole structure 106 as depicted in FIGS. 1-3.

The molded article may have a density of less than about 0.45 g/cm3, preferably less than about 0.4 g/cm3, more preferably less than about 0.35 g/cm3. In various embodiments, the molded article may have a density of from about 0.1 to about 0.45 g/cm3, or a density of from about 0.1 to about 0.4 g/cm 3 , or a density of from about 0.1 to about 0.35 g/cm3.

In some aspects, the material is a thermoplastic material when it is combined with other elements to make the midsole, sole structure, or article of footwear, and remains thermoplastic, and is a thermoplastic material in the final product (e.g., in the finished midsole, finished sole structure or finished article of footwear). In other aspects, the material is a thermoplastic material when it is combined with other elements to make the midsole, sole structure, or article of footwear, and is subsequently cured into a crosslinked material in the manufacturing process, and thus is a crosslinked material in the final product. In yet other aspects, the material is crosslinked before being combined with other elements of the midsole, sole structure or article of footwear during the manufacturing process, and thus is a crosslinked material in the final product.

In some aspects, the one or more polymers may include olefinic homopolymers, olefinic copolymers, or blends thereof. Examples of olefinic polymers include polyethylene, polypropylene, and combinations thereof. In other aspects, the one or more polymers may include one or more ethylene copolymers, such as, ethylene-vinyl acetate (EVA) copolymers, EVOH copolymers, ethylene-ethyl acrylate copolymers, ethylene-unsaturated mono-fatty acid copolymers, and combinations thereof.

In further aspects, the one or more polymers may include one or more polyacrylates, such as polyacrylic acid, esters of polyacrylic acid, polyacrylonitrile, polyacrylic acetate, polymethyl acrylate, polyethyl acrylate, polybutyl acrylate, polymethyl methacrylate, and polyvinyl acetate; including derivatives thereof, copolymers thereof, and any combinations thereof.

In yet further aspects, the one or more polymers may include one or more ionomeric polymers. In these aspects, the ionomeric polymers may include polymers with carboxylic acid functional groups, sulfonic acid functional groups, salts thereof (e.g., sodium, magnesium, potassium, etc.), and/or anhydrides thereof. For instance, the ionomeric polymer(s) may include one or more fatty acid-modified ionomeric polymers, polystyrene sulfonate, ethylene-methacrylic acid copolymers, and combinations thereof.

In further aspects, the one or more polymers may include one or more styrenic block copolymers, such as acrylonitrile butadiene styrene block copolymers, styrene acrylonitrile block copolymers, styrene ethylene butylene styrene block copolymers, styrene ethylene butadiene styrene block copolymers, styrene ethylene propylene styrene block copolymers, styrene butadiene styrene block copolymers, and combinations thereof.

In further aspects, the one or more polymers may include one or more polyamide copolymers (e.g., polyamide-polyether copolymers) and/or one or more polyurethanes (e.g., crosslinked polyurethanes and/or thermoplastic polyurethanes). Alternatively, the one or more polymers may include one or more natural and/or synthetic rubbers, such as polybutadiene and polyisoprene.

In one aspect, the resilient material is a foam. When the material is foamed, the resilient material may be foamed using a physical blowing agent which phase transitions to a gas based on a change in temperature and/or pressure, or a chemical blowing agent which forms a gas when heated above its activation temperature. For example, the chemical blowing agent may be an azo compound such as adodicarbonamide, sodium bicarbonate, and/or an isocyanate.

In some embodiments, the foam may be a crosslinked foam. In these embodiments, a peroxide-based crosslinking agent such as dicumyl peroxide may be used. Furthermore, the foam may include one or more fillers such as pigments, modified or natural clays, modified or unmodified synthetic clays, talc glass fiber, powdered glass, modified or natural silica, calcium carbonate, mica, paper, wood chips, and the like.

In another example, when the resilient material is a foam, the material may be foamed during a molding process, such as an injection molding process. A thermoplastic material may be melted in the barrel of an injection molding system and combined with a physical or chemical blowing agent and optionally a crosslinking agent (in order to make a crosslinked foam), and then injected into a mold under conditions which activate the blowing agent, forming a molded foam.

Optionally, when the resilient material is a foam, the foam may be a compression molded foam. Compression molding may be used to alter the physical properties (e.g., density, stiffness and/or durometer) of a foam, or to alter the physical appearance of the foam (e.g., to fuse two or more pieces of foam, to shape the foam, etc.), or both.

The compression molding process desirably starts by forming one or more foam preforms, such as by injection molding and foaming a material, e.g., a resilient material, by forming foamed particles or beads, by cutting foamed sheet stock, and the like. The compression molded foam may then be made by placing the one or more foam preforms in a compression mold, and applying sufficient pressure to the one or more preforms to compress the one or more foam preforms in a closed mold. Once the mold is closed, sufficient heat and/or pressure is applied to the one or more foam preforms in the closed mold for a sufficient duration of time to alter the foam preform(s), to form a skin on the outer surface of the compression molded foam, or to fuse individual foam particles to each other, to permanently or semi-permanently increase the density of the foam(s), or any combination thereof. Following the heating and/or application of pressure, the mold is opened and the molded foam article is removed from the mold.

In another aspect, the resilient material is an unfoamed solid. The material may be shaped using a molding process, including an injection molding process. In one example, when the material is an elastomeric material, the elastomeric material (e.g., uncured rubber) may be mixed in a Banbury mixer with an optional filler and a curing package such as, for example, a UV curing package or a thermal curing package including a sulfur-based or peroxide-based curing package, calendared, formed into shape, placed in a mold, and cured (e.g., using a UV curing process or a thermal curing process such as a vulcanization process).

The polymeric materials described herein are understood to comprise, consist essentially of, or consist of one or more polymers. All the one or more polymers present in a polymeric material constitute the polymeric component of the polymeric material. Similarly, when a polymeric material comprises one or more non-polymer additives, all of the non-polymer additives present in the polymeric material constitute the non-polymeric component of the polymeric material. The polymeric material may be a thermoplastic material, in which the one or more polymers of the polymeric material comprises, consists essentially of, or consists of one or more thermoplastic. A thermoplastic is a polymer that is a solid when cooled, and which can be repeatedly softened and melted on heating. The polymeric material may be an elastomeric material, in which the one or more polymers of the elastomeric material comprises, consists essentially of, or consist of one or more elastomer. An elastomer is a polymer having an elongation at break of greater than 100 percent, such as of greater than 200 percent, or of greater than 400 percent, as determined using ASTM D-412-98 at 25 degrees Celsius. An elastomeric material is a composition having an elongation at break of greater than 100 percent, such as of greater than 200 percent, of or greater than 400 percent, as determined using ASTM D-412-98 at 25 degrees Celsius.

The one or more polymers of a polymeric material may include one or more of a variety of polymers, including homopolymers and copolymers and combinations of homopolymers and copolymers. The one or more polymers may comprise, consist essentially of, or consist of a polymer chosen from a polyurethane, a polyurea, a polyester, a polyether, a polyamide, a polyimide, a polyolefin, a polystyrene, a polysilane, a polysiloxane, a polycarbonate, a polyacetate, including homopolymers and copolymers thereof, and any combination thereof. The one or more polymers may comprise, consist essentially of, or consist of a polymer chosen from a polyurethane, a polyester, a polyamide, a polystyrene, a polyolefin, including homopolymers and copolymers thereof, and any combination thereof. The one or more polymers may comprise, consist essentially of, or consist of one or more polyurethane. Examples of polyurethanes include thermoplastic polyurethanes (TPUs), such as polyester-polyurethane copolymers and polyether-polyurethane copolymers, including thermoplastic elastomeric polyurethanes. The one or more polymers may comprise, consist essentially of, or consist of one or more polyester. Examples polyesters include polyester homopolymers such as polyethylene terephthalate (PET), and polyester copolymers such as polyetheresters, including thermoplastic polyester copolymers. The one or more polymers may comprise, consist essentially of, or consist of one or more polyamide. Examples of polyamide homopolymers include thermoplastic polyamide homopolymers such as Nylon-6, Nylon-6,6, and Nylon-11. Examples of polyamide copolymers include thermoplastic polyamide copolymers such as thermoplastic elastomeric polyamide block copolymers, for example polyether block amide (PEBA) thermoplastic elastomers. The one or more polymers may comprise, consist essentially of, or consist of one or more polystyrene. The one or more polystyrene may comprise, consist essentially of, or consist of thermoplastic polystyrene homopolymers, for example one or more thermoplastic polystyrene homopolymers. Examples of polystyrenes also include polystyrene copolymers such as thermoplastic polystyrene copolymers and thermoplastic polystyrene copolymer elastomers. Examples of polystyrene copolymers include styrene-butadiene-styrene (SBS) copolymers and styrene-ethylene-butadiene-styrene (SEBS) copolymers. The one or more polymers may comprise, consist essentially of, or consist of one or more polyolefin. The one or more polyolefin may comprise, consist essentially of, or consist of one or more thermoplastic polyolefin, for example one or more thermoplastic polyolefin elastomer, including one or more thermoplastic polyolefin homopolymer elastomer, or one or more thermoplastic polyolefin copolymer elastomer, or a combination of both. Examples of polyolefin homopolymers include polyethylene and polypropylene. Examples of polyolefin copolymers include copolymers comprising two olefinic monomeric units, such as polyethylene-polypropylene copolymers, as well as copolymers comprising one olefinic monomeric unit, such as ethylene-vinyl acetate copolymers (EVA) and ethylene-vinyl alcohol (EVOH) copolymers.

The polymeric material may comprise from about 5 weight percent to about 100 weight percent of the polymeric component based on a total weight of the polymeric material. The polymeric component can comprise from about 15 weight percent to about 100 weight percent, from about 30 weight percent to about 100 weight percent, from about 50 weight percent to about 100 weight percent, or from about 70 weight percent to about 100 weight percent of the polymeric material. When the polymeric material comprises a non-polymeric component, the non-polymeric component may comprise from about 1 weight percent to about 20 weight percent, or from about 1 weight percent to about 10 weight percent, or from about 1 weight percent to about 5 weight percent based on a total weight of the polymeric material. As used herein, the terms “consist essentially of”, “consists essentially of” and “consisting essentially of” refer to compositions which consist of less than 1 weight percent of materials other than those recited, based on a total weight of the composition. For example, “a polymeric material consisting essentially of thermoplastics” is understood to be a polymeric material which included less than 1 weight percent of non-thermoplastic polymers and non-polymeric materials; while “a polymeric material comprising a polymeric component consisting essentially of thermoplastics” is understood to include a polymeric component in which less than 1 weight percent of the polymers present are non-thermoplastic polymers, but this polymeric material may include more than 1 weight percent of non-polymeric materials.

The polymeric material may be a material which polymerizes or crosslinks or both polymerizes and crosslinks during the process of forming the component or during the process of forming the sole structure. The polymerization or crosslinking may be initiated by including a chemical polymerization or crosslinking initiator in the polymeric material (e.g., a chemical which initiates polymerization or crosslinking reactions within the polymeric material when it is exposed to thermal energy, UV light, or another form of actinic radiation), or the polymerization or crosslinking may be initiated by mixing together two compositions which react to produce polymerization or crosslinking reactions, or by exposing a polymeric material to a form of actinic radiation in sufficient quantity to polymerize pre-polymers or oligomers present in the exposed material, or to crosslink polymers present in the exposed polymeric material. In compositions in which polymerization occurs, the material may initially comprise one or more pre-polymers or oligomers which react and polymerize during the manufacturing process, resulting in a support or sole structure comprising the reacted polymeric material. In compositions in which crosslinking occurs, the material may initially comprise one or more crosslinkable pre-polymers, oligomers, or polymers which react with crosslinking agents or crosslinking energy and form crosslinked polymers during the manufacturing process, resulting in a component or sole structure comprising a crosslinked polymeric material. The resulting reacted polymeric material may be a thermoset material. Similarly, the initial polymeric material may be a thermosetting thermoplastic material (e.g., a polymeric material which comprises one or more thermoplastics and a crosslinking agent before it is thermally processed), with the resulting crosslinked polymeric material being a thermoset material (e.g., after the crosslinking agent reacts with the thermoplastics and crosslinks them, and the resulting thermoset material solidifies). One example of this is a thermosettable molten thermoplastic material comprising a thermally-activated crosslinking agent and a foaming agent, where the thermally-activated crosslinking agent is activated during a foaming process, producing in a thermoset foam material.

Optionally, the polymeric material may comprise one or more additives. Examples of additives include fillers, polymerization initiators, crosslinking agents, UV light absorbers, anti-oxidants, processing aids such as lubricants and plasticizers, and colorants, such as pigments and dyes. Fillers may include non-polymeric fillers such as silica, clay, and titanium dioxide. Fillers may include polymeric fillers such as polymeric fibers and finely-ground polymeric powders, including ground thermoset rubber. Colorants such as naturally-occurring and synthetic pigments and dyes may be used. The polymeric material may comprise one or more additives at a concentration of from about 0.1 weight percent to about 20 weight percent, or from about 0.2 weight percent to about 10 weight percent, or from about 0.5 weight percent to about 5 weight percent, based on a total weight of the polymeric material.

The polymeric material may be a solid polymeric material, meaning that the polymeric material is unfoamed. The solid polymeric material may be an extruded material, which results in the component comprising the extruded material being an extruded component, such as an extruded film or sheet. The solid polymeric material may be a molded material, which results in the component comprising the molded material being a molded component. Various methods may be used, including compression molding and injection molding. For example, the solid polymeric material may be an injection molded material, which results in the component comprising the injection molded material being an injection molded component.

The polymeric material may be a foamed polymeric material, meaning that the polymeric material has a multi-cellular foam structure. The foamed polymeric material may have an open-cell structure, meaning that the majority of the cells of the multi-cellular foam are open cells. Alternatively, the foamed polymeric material may have a closed-cell structure, meaning that the majority of the cells of the multi-cellular foam are closed cells.

The foamed polymeric material may be an extruded foamed material, which results in the component comprising the extruded foamed material being an extruded foamed component, such as an extruded foam sheet. The foamed polymeric material may be a molded foamed material, which results in the component comprising the molded foamed material being a molded foamed component. Various methods may be used, including compression molding and injection molding. For example, the foamed polymeric material may be an injection molded and foamed material, meaning that the material was foamed and molded using an injection molding process, which results in the component comprising the injection molded and foamed material being an injection molded foamed component.

The polymeric material may comprise one or more foaming (blowing) agents. As understood in the art, foaming agents are substances that react, decompose or vaporize to produce quantities of gases or vapors. A chemical foaming agent is a compound which, when reacted with a second chemical or on decomposition, release a gas. Examples of chemical foaming agents include sodium bicarbonate, ammonium carbonate, ammonium bicarbonate, calcium azide, azodicarbonamide, hydrazocarbonamide, benzenesulfonyl hydrazide, dinitrosopentamethylene tetramine, toluenesulfonyl hydrazide, p,p′-oxybis(benzenesulfonylhydrazide), azobisisobutyronitrile, barium azodicarboxylate, and any combination thereof. A physical blowing agent is a compound which phase transitions from a solid, liquid or supercritical fluid to a gas when the temperature, pressure, or temperature and pressure are changed. Physical blowing agents include low-boiling-point hydrocarbons, including hydrocarbons such as isobutene and pentane, and partially halogenated hydrocarbons such as partially halogenated fluorochlorohydrocarbons, inert gasses, and supercritical fluids. The foaming agent may be a supercritical fluid, such as supercritical carbon dioxide (CO2) or supercritical nitrogen (N2). The polymeric material may comprise one or more foaming agents, and the one or more foaming agents may include a chemical foaming agent, a physical foaming agent, or a combination of both a chemical foaming agent and a physical foaming agent. The foamed material may be a chemically-blown foamed material, meaning that a chemical foaming agent was used to foam the polymeric material. The foamed material may be a physically-blown foamed material, meaning that a physical foaming agent was used to foam the polymeric material. The foamed material may be both a physically-blown and chemically-blown foamed material, meaning that both physical and chemical blowing agents were used to foam the polymeric material.

When a foaming agent is used, prior to the foaming step, the foaming agent may be present in the polymeric material in an amount effective to foam the polymeric material into a multicellular foam during the manufacturing process. The amount of foaming agent may be measured as the concentration of foaming agent by weight in the polymeric material prior to the foaming step. An amount of foaming agent is considered effective when the foaming process results in at least a 10 percent increase in the volume of the polymeric material. The foaming process may result at least a 20 percent increase in the volume of the polymeric material, or in at least a 30 percent increase in the volume of the polymeric material. The polymeric material may comprise from about 1 percent to about 30 percent by weight based on a total weight of the polymeric material, or from about 1 percent to about 20 percent by weight, or from about 1 percent to about 10 percent by weight of the foaming agent based on a total weight of the polymeric material. The polymeric material may comprise a concentration of the foaming agent sufficient to expand the polymeric material by at least 100 percent by volume based on an initial volume of the polymeric material prior to foaming, optionally by 100 percent to 900 percent by volume, or by 200 percent to 500 percent by volume, or by 300 percent to 400 percent by volume, based on an initial volume of the polymeric material prior to foaming.

The foamed polymeric material may have a density of from about 0.01 to about 0.7 grams per cubic centimeter, or of from about 0.05 to about 0.5 grams per cubic centimeter, or of from about 0.1 to about 0.4 grams per cubic centimeter. The specific gravity (S.G.) and/or density may be measured using a digital balance or a Densicom Tester (Qualitest, Plantation, Florida, USA). Each sample is weighed and then is submerged in a distilled water bath (at 22 degrees Celsius plus or minus 2 degrees Celsius). To avoid errors, air bubbles on the surface of the samples are removed, e.g., by wiping isopropyl alcohol on the sample before immersing the sample in water, or using a brush after the sample is immersed. The weight of the sample in the distilled water is recorded. The specific gravity is calculated by dividing the weight (in grams) of the sample in air by (the weight (in grams) of the sample in air minus the weight (in grams) of the sample in water). The density of the sample (in grams per cubic centimeter) is calculated by multiplying the S.G. by the density of water.

The foamed polymeric material may have a split-tear strength ranging from about 1.0 to about 10 kilograms per centimeter, or ranging from about 1.6 to about 5.0 kilograms per centimeter, or ranging from about 2.0 to about 4.0 kilograms per centimeter. Split tear for foams can be measured using ASTM D3574-95. Although this method is directed to bonded and molded urethane foams, it can be used on other foamed materials in accordance with the present disclosure. A sample of foamed material having a thickness of 10 mm ±1 mm. If the foamed material has an outer skin, the outer skin should not be present on the test sample. A 3 cm long cut is placed in the center of one end of the sample, and marked in five successive 2 cm portions along the edge of the sample. The sample is tested as described in ASTM D3574-95.

The foamed polymeric material may have a tensile strength ranging from about 5 to about 25 kilograms per centimeter squared, or ranging from about 10 to about 23 kilograms per centimeter squared, or ranging from about 15 to about 22 kilograms per centimeter squared. The tensile strength may be measured on a die cut sample of the foamed material in the shape of a dumbbell of a standard size such as a 2.5 centimeters in width by 11.5 centimeters in length, with a minimum thickness of 3 to 4 millimeters. The dumbbell follows the shape described in ASTM D412, die C. The sample is loaded symmetrically into and tested using a long travel extensometer such as the Instron 2603-080 which allows for a minimum of 1000 percent strain with a gauge length of 25 millimeters and a resolution of at least 0.1 millimeters. The tensile value at the failure point of the sample (the point during testing when the load value initially drops) is the tensile strength of the sample.

The foamed polymeric material may have an energy return of at least 50 percent, or at least 65 percent, or at least 70 percent, or at least 75 percent. The energy return of the foamed polymeric material may range from about 50 to about 95 percent, or from about 60 to about 90 percent, or from about 65 to about 85 percent. Force/displacement behavior for a foamed material or cushioning element, including energy return, may be measured using an Instron Electropuls E10000 (Instron, Norwood, Massachusetts, USA) with a stainless-steel 45 mm circular cross section impact geometry, using a foam sample having a thickness of approximately 10 mm. Samples may be was evaluated using a “running” and/or “walking” compression cycle. A “running” compression cycle may consists of compressing samples under displacement control from 0 N to 300 N and back to 0 N in 180 ms, followed by a pause of 400 ms for a total of about 1.7 Hz. The “walking” compression cycle may consist of compression samples from 0 N to 144 N and back to 0 N in 600 ms followed by a pause of 400 ms for a total of about 1 Hz. The corresponding force-displacement data can be used to calculate modulus (stiffness), energy return, compression set, fatigue behavior, and other properties over many cycles. Typical characterization using the compression sequence above are run for 5000 cycles, which simulates approximately about 5-10 miles of walking/running and takes about 45 minutes of testing time on the Electropuls. Longer runs up to 100,000 compression cycles are done to simulate accelerated materials response to about 100-200 miles of use. Energy input is taken as the integral of the force-displacement curve during compression force loading. Energy output is taken as the integral of the force displacement curve during unloading. Hysteresis is taken as the ratio: (energy output)/(energy input), which, when multiplied by 100, is the percentage of energy returned by the foam.

The following clauses provide an exemplary configuration for an article of footwear and sole structure described above.

Clause 1. A method of molding comprising:
mixing a molten polymeric material with a blowing agent;
mixing a supercritical fluid with the molten polymeric material and the blowing agent, thereby forming a first mixture;
injecting the first mixture into a mold cavity, wherein the mold cavity includes a lattice;
solidifying the first mixture within the mold cavity, thereby forming a foamed article; and
removing the foamed article from the mold cavity.

Clause 2. The method of clause 1, wherein the molten polymeric material is a thermoplastic polyurethane (TPU).

Clause 3. The method of clause 1, wherein the lattice comprises a plurality of chambers.

Clause 4. The method of clause 3, wherein the first mixture is injected directly into the plurality of chambers of the lattice.

Clause 5. The method of clause 4, wherein the first mixture completely fills the plurality of chambers of the lattice and expands within the plurality of chambers.

Clause 6. The method of clause 3, wherein the lattice includes:
a first end and a second end opposite the first end;
a first edge and a second edge disposed opposite the first edge; and
the plurality of chambers surrounding one or more cavities, wherein the plurality of chambers extend from the first end to the second end and from the first edge to the second edge.

7. The method of clause 6, wherein each of the plurality of chambers includes:
one or more bases;
one or more ribs connected between the one or more bases;
a footing; and
one or more posts coupled with the footing and the one or more ribs.

Clause 8. The method of clause 7, wherein an opening is disposed between adjacent posts of the one or more posts.

Clause 9. The method of clause 6, wherein the plurality of chambers include a first surface surrounding the one or more cavities, and wherein the plurality of chambers include a second surface disposed opposite the first surface, the second surface being a rounded surface of the mold cavity.

Clause 10. The method of clause 1, wherein the supercritical fluid is one of either carbon dioxide or nitrogen.

Clause 11. The method of clause 1, wherein the first mixture is a single phase solution at supercritical temperatures.

Clause 12. The method of clause 1, wherein the molten polymeric material comprises an elastomeric thermoplastic polyurethane selected from the group consisting of thermoplastic polyester-polyurethanes, polyether-polyurethanes, and polycarbonate-polyurethanes.

Clause 13. The method of clause 1, wherein the molten polymeric material comprises at least one of an elastomeric thermoplastic polyester-polyurethane and an elastomeric thermoplastic polyether-polyurethane.

Clause 14. The method of clause 9, wherein the molten polymeric material comprises at least an elastomeric thermoplastic polyether-polyurethane that is a reaction product of diphenylmethane diisocyanate.

Clause 15. An article of footwear produced by the method of clause 1.

Clause 16. The method of clause 1, wherein the foamed article is a midsole for an article of footwear.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

We claim:

1. A method of molding comprising:
mixing a molten polymeric material with a blowing agent;
mixing a supercritical fluid with the molten polymeric material and the blowing agent, thereby forming a first mixture;
injecting the first mixture into a mold cavity, wherein the mold cavity includes a lattice;
solidifying the first mixture within the mold cavity, thereby forming a foamed article; and
removing the foamed article from the mold cavity.

2. The method of claim 1, wherein the molten polymeric material is a thermoplastic polyurethane (TPU).

3. The method of claim 1, wherein the lattice comprises a plurality of chambers.

4. The method of claim 3, wherein the first mixture is injected directly into the plurality of chambers of the lattice.

5. The method of claim 4, wherein the first mixture completely fills the plurality of chambers of the lattice and expands within the plurality of chambers.

6. The method of claim 3, wherein the lattice includes:
a first end and a second end opposite the first end;
a first edge and a second edge disposed opposite the first edge; and
the plurality of chambers surrounding one or more cavities, wherein the plurality of chambers extend from the first end to the second end and from the first edge to the second edge.

7. The method of claim 6, wherein each of the plurality of chambers includes:
one or more bases;
one or more ribs connected between the one or more bases;
a footing; and
one or more posts coupled with the footing and the one or more ribs.

8. The method of claim 7, wherein an opening is disposed between adjacent posts of the one or more posts.

9. The method of claim 6, wherein the plurality of chambers include a first surface surrounding the one or more cavities, and wherein the plurality of chambers include a second surface disposed opposite the first surface, the second surface being a rounded surface of the mold cavity.

10. The method of claim 1, wherein the supercritical fluid is one of either carbon dioxide or nitrogen.

11. The method of claim 1, wherein the first mixture is a single phase solution at supercritical temperatures.

12. The method of claim 1, wherein the molten polymeric material comprises an elastomeric thermoplastic polyurethane selected from the group consisting of thermoplastic polyester-polyurethanes, polyether-polyurethanes, and polycarbonate-polyurethanes.

13. The method of claim 1, wherein the molten polymeric material comprises at least one of an elastomeric thermoplastic polyester-polyurethane and an elastomeric thermoplastic polyether-polyurethane.

14. The method of claim 9, wherein the molten polymeric material comprises at least an elastomeric thermoplastic polyether-polyurethane that is a reaction product of diphenylmethane diisocyanate.

15. An article of footwear produced by the method of claim 1.

16. The method of claim 1, wherein the foamed article is a midsole for an article of footwear.
